(19) United States
(12) Patent Application Publication
(10) Pub. No.: US 2015/0361212 A1
(43) Pub. Date: Dec. 17, 2015

(54) POLYLACTIC RESIN COMPOSITION, MOLDED PRODUCT, AND METHOD OF PRODUCING POLYLACTIC RESIN COMPOSITION

(71) Applicant: Toray Industries, Inc., Tokyo (JP)

(72) Inventors: Yoshitake Takahashi, Nagoya (JP); Tatsuya Nagano, Tokai (JP); Hiroyuki Ome, Nagoya (JP)

(21) Appl. No.: 14/763,647

(22) PCT Filed: Feb. 3, 2014
(86) PCT No.: PCT/JP2014/052385

§ 371 Date: Jul. 27, 2015

(30) Foreign Application Priority Data
Feb. 19, 2013 (JP) 2013-029655

(51) Int. Cl. C08G 63/08

(52) U.S. Cl. CPC C08G 63/08

(57) ABSTRACT

A polylactic acid resin composition includes 100 parts by weight of a polylactic acid block copolymer constituted of a poly-L-lactic acid segment(s) containing as a major component L-lactic acid and a poly-D-lactic acid segment(s) containing as a major component D-lactic acid; and 0.05 to 2 parts by weight of a cyclic compound containing a glycidyl group or acid anhydride. The polylactic acid resin composition has better mechanical properties, durability, and heat resistance, as well as excellent wet heat properties and dry heat properties, which are given by the end-capping effect of a cyclic compound containing a glycidyl group or acid anhydride exerted on the polylactic acid resin composition.

### TECHNICAL FIELD

This disclosure relates to a polylactic acid resin composition having better mechanical properties, durability, and heat resistance, as well as excellent wet heat properties and dry heat properties, provided by the end-capping effect of a cyclic compound containing a glycidyl group or acid anhydride exerted on the polylactic acid resin composition, a molded product, and a method of producing the polylactic acid resin composition.

### BACKGROUND

Polylactic acid is a macromolecule which can be practically subjected to melt molding and, because of its biodegradable properties, it has been developed as biodegradable plastics that are degraded, after use, under natural environment to be released as carbon dioxide gas and water. In addition, since the raw material of polylactic acid itself is a renewable resource (biomass) originated from carbon dioxide and water, release of carbon dioxide after its use neither increases nor decreases carbon dioxide in the global environment. Such a carbon-neutral nature of polylactic acid is drawing attention in recent years, and use of polylactic acid as an eco-friendly material has been expected. Further, lactic acid, which is the monomer constituting polylactic acid, can be inexpensively produced by fermentation methods using microorganisms in recent years, and polylactic acid is therefore being studied as a material alternative to general-purpose polymers made of petroleum-based plastics.

In WO 2006/104092, an isocyanurate compound containing a glycidyl group is added to polylactic acid to perform end-capping of the terminal carboxyl group of the polylactic acid, thereby decreasing the carboxyl terminal concentration. Fibers obtained by this end-capped polylactic acid had high strength retention after a hydrolysis resistance test, and better color tones than those of fibers end-capped with polycarbodiimide.

In JP 2007-23445 A, similarly to WO 2006/104092, an isocyanurate compound is added to polylactic acid to perform end-capping of the polylactic acid, and a leather-like sheet is produced using a combination of a non-woven fabric produced from the polylactic acid and a macromolecular elastic material. Also in that technique, improved hydrolysis resistance of the polylactic acid could confirmed, and it was shown that a favorable manufacturing environment can be achieved because generation of irritating odor can be suppressed during production.

In JP 2002-30208 A, a polylactic acid stereocomplex composed of poly-L-lactic acid and poly-D-lactic acid is produced as a polylactic acid resin, and a carbodiimide compound is added to this polylactic acid stereocomplex in an attempt to increase its heat resistance and hydrolysis resistance. A polylactic acid fiber in which the end-capping with carbodiimide was carried out showed favorable heat resistance in a heat resistance test at 200° C.

In JP 2006-274481 A, an isocyanurate compound is added to a polylactic acid stereocomplex prepared by melt mixing of poly-L-lactic acid and poly-D-lactic acid, to prepare a fiber having excellent heat resistance and hydrolysis resistance. The polylactic acid stereocomplex prepared by melt mixing of poly-L-lactic acid and poly-D-lactic acid is provided with molecular orientation by stretching of the fiber to improve the capacity to form stereocomplex crystals. By this, a polylactic acid fiber having excellent heat resistance and hydrolysis resistance can be prepared.

However, polylactic acids have less heat resistance and durability compared to petroleum-based plastics at present. For example, when a polylactic acid fiber is applied to clothing, there is a problem that application of a household iron at a temperature of not less than the medium temperature to a fabric composed of polylactic acid may cause melting of the fabric surface. Moreover, in industrial materials, the fiber has a drawback in that its repeated use is difficult because of the low hydrolysis resistance.

As a means of improving heat resistance and hydrolysis resistance of these polylactic acids, addition of a carbodiimide compound or isocyanurate compound to the polylactic acids has been attempted. The terminal carboxyl group of polylactic acid reacts with these compounds to achieve end-capping, resulting in suppression of hydrolyzability.

On the other hand, as a means of improving heat resistance of polylactic acid, polylactic acid stereocomplexes are drawing attention. Polylactic acid stereocomplexes are different from conventional homocrystals in that optically active poly-L-lactic acid and poly-D-lactic acid are mixed together to form stereocomplex crystals. The melting point derived from the polylactic acid stereocomplex crystals reaches 220° C., which is 50° C. higher than the melting point derived from polylactic acid homocrystals, 170° C. so that improvement of the heat resistance can be expected. At present, by utilization of the end-capping technique and stereocomplex formation technique, attempts are being made to expand use of polylactic acid to uses for clothing and uses for industrial materials, in addition to the conventional uses for biodegradability purposes (see, for example, WO 2006/104092, JP 2007-23445 A, JP 2002-30208 A, and JP 2006-274481 A).

However, although WO 2006/104092 and JP 2007-23445 A improve hydrolysis resistance of polylactic acid fibers, the melting points of these polylactic acid fibers are about 170° C. so that there remains a problem in their use in clothing or industrial materials.

In the technique disclosed in JP 2002-30208 A, the carboxyl terminal concentration is not sufficiently low so that there remains a problem in long-term wet heat stability. Moreover, although the technique is applicable to fibers, its application to other uses is difficult at present.

In the technique disclosed in JP 2006-274481 A, sufficient improvement of the heat resistance is difficult since a stereocomplex obtained by melt mixing normally contains residual homocrystals. Moreover, although the technique is applicable to fibers, its application to other uses is difficult at present.

In view of the above-described circumstances, a new technique has been demanded to improve the heat resistance and hydrolysis resistance of polylactic acid stereocomplexes and thereby expanding their uses to uses other than application to fibers.

Formation of a polylactic acid block copolymer is drawing attention as a new method of forming a polylactic acid stereocomplex. The polylactic acid block copolymer is produced by covalent bonding between a poly-L-lactic acid segment(s) containing as a major component L-lactic acid and a poly-D-lactic acid segment(s) containing as a major component D-lactic acid. Even when the polylactic acid block copolymer has a high molecular weight, it has excellent stereocomplex crystal-forming capacity, and the melting point derived from stereocomplex crystals can be observed. Therefore, a material having excellent thermal properties such as heat resistance and crystallization properties can be obtained from the copolymer. Because of this, application of the copolymer to fibers, films, and resin molded articles having high melting points and high crystallinities is being attempted. Also in this technique, although excellent heat resistance and crystallization properties can be achieved, improvement of hydrolysis resistance and wet heat stability is demanded.

It could therefore be helpful to provide a polylactic acid resin composition that forms a polylactic acid stereocomplex having better mechanical properties, durability, and heat resistance, as well as excellent wet heat properties and dry heat properties, a molded product, and a method of producing the polylactic acid resin composition.

### SUMMARY

We thus provide polylactic acid resin compositions having the following constitution. That is, a polylactic acid resin composition comprising: 100 parts by weight of a (A) polylactic acid block copolymer constituted by a poly-L-lactic acid segment(s) containing as a major component L-lactic acid and a poly-D-lactic acid segment(s) containing as a major component D-lactic acid; and 0.05 to 2 parts by weight of a (B) cyclic compound having a molecular weight of not more than 800 and containing a glycidyl group or acid anhydride; wherein the degree of stereocomplexation (Sc) satisfies Equation (1):

Sc=ΔHh/(ΔHl−ΔHh)×100>80 (1)

wherein

ΔHh: the heat of fusion of stereocomplex crystals (J/g) in DSC measurement of the polylactic acid resin composition, wherein the temperature is increased at a heating rate of 20° C./min.; and

ΔHl: the heat of fusion of crystals (J/g) of poly-L-lactic acid alone and crystals of poly-D-lactic acid alone in DSC measurement of the polylactic acid resin composition, wherein the temperature is increased at a heating rate of 20° C./min.

The (B) cyclic compound containing a glycidyl group or acid anhydride is preferably an isocyanurate compound represented by General Formula (1):

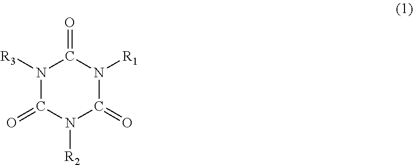

(wherein R₁-R₃ may be the same or different, and at least one of R₁-R₃ represents a glycidyl group while each of the others represents a functional group selected from the group consisting of hydrogen, C₁-C₁₀ alkyl, hydroxyl, and allyl).

The compound represented by General Formula (1) is preferably at least one compound selected from the group consisting of diallyl monoglycidyl isocyanurate, monoallyl diglycidyl isocyanurate, and triglycidyl isocyanurate.

The (B) cyclic compound containing a glycidyl group is preferably at least one compound selected from the group consisting of diglycidyl phthalate, diglycidyl terephthalate, diglycidyl tetrahydrophthalate, diglycidyl hexahydrophthalate, and cyclohexane-dimethanol diglycidyl ether.

The (B) cyclic compound containing a glycidyl group and/or acid anhydride is preferably at least one compound selected from the group consisting of phthalic anhydride, maleic anhydride, pyromellitic dianhydride, trimellitic anhydride, 1,2-cyclohexanedicarboxylic anhydride, and 1,8-naphthalenedicarboxylic anhydride.

The carboxyl terminal concentration of the polylactic acid resin composition is preferably not more than 10 eq/ton.

The weight average molecular weight of the polylactic acid resin composition after 100 hours of moist heat treatment at 60° C. under 95% RH is preferably not less than 80% of the weight average molecular weight before the moist heat treatment.

The crystal melting enthalpy of the polylactic acid resin composition is preferably not less than 30 J/g at not less than 190° C. during DSC measurement in which the temperature is increased to 250° C.

The (A) polylactic acid block copolymer is preferably obtained by mixing poly-L-lactic acid and poly-D-lactic acid in Combination 1 and/or Combination 2 to obtain a mixture having a weight average molecular weight of not less than 90,000 and a degree of stereocomplexation (Sc) satisfying Equation (2), and then performing solid-state polymerization at a temperature lower than the melting point of the mixture:

(Combination 1) one of the poly-L-lactic acid and the poly-D-lactic acid has a weight average molecular weight of 60,000 to 300,000, and the other has a weight average molecular weight of 10,000 to 100,000;

(Combination 2) the ratio between the weight average molecular weight of the poly-L-lactic acid and the weight average molecular weight of the poly-D-lactic acid is not less than 2 and less than 30;

Sc=ΔHh/(ΔHl−ΔHh)×100>60 (2)

wherein

ΔHh: the heat of fusion of stereocomplex crystals (J/g) in DSC measurement of the mixture of poly-L-lactic acid and poly-D-lactic acid, wherein the temperature is increased at a heating rate of 20° C./min.; and

ΔHl: the heat of fusion of crystals (J/g) of poly-L-lactic acid alone and crystals of poly-D-lactic acid alone in DSC measurement of the mixture of poly-L-lactic acid and poly-D-lactic acid, wherein the temperature is increased at a heating rate of 20° C./min.

The (A) polylactic acid block copolymer is preferably obtained by mixing poly-L-lactic acid and poly-D-lactic acid in Combination 3 and/or Combination 4 to obtain a mixture having a weight average molecular weight of not less than 90,000 and a degree of stereocomplexation (Sc) satisfying Equation (2), and then performing solid-state polymerization at a temperature lower than the melting point of the mixture:

(Combination 3) one of the poly-L-lactic acid and the poly-D-lactic acid has a weight average molecular weight of 120,000 to 300,000, and the other has a weight average molecular weight of 30,000 to 100,000;

(Combination 4) the ratio between the weight average molecular weight of the poly-L-lactic acid and the weight average molecular weight of the poly-D-lactic acid is not less than 2 and less than 30;

Sc=ΔHh/(ΔHl−ΔHh)×100>60 (2)

wherein

ΔHh: the heat of fusion of stereocomplex crystals (J/g) in DSC measurement of the mixture of poly-L-lactic acid and poly-D-lactic acid, wherein the temperature is increased at a heating rate of 20° C./min.; and

ΔHl: the heat of fusion of crystals (J/g) of poly-L-lactic acid alone and crystals of poly-D-lactic acid alone in DSC measurement of the mixture of poly-L-lactic acid and poly-D-lactic acid, wherein the temperature is increased at a heating rate of 20° C./min.

Polydispersity, which is represented as the ratio between the weight average molecular weight and the number average molecular weight, of the polylactic acid resin composition is preferably not more than 2.5.

The weight average molecular weight of the polylactic acid resin composition is preferably 100,000 to 500,000.

The polylactic acid resin composition preferably further comprises (b) poly-L-lactic acid and/or (c) poly-D-lactic acid.

We also provide a molded product comprising the polylactic acid resin composition.

We further provide a method of producing the polylactic acid resin composition and having any one of the following constitutions (I) to (III). That is,

(I) a method of producing the polylactic acid resin composition, the method comprising:

mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000; or the ratio between the weight average molecular weight of the poly-L-lactic acid and the weight average molecular weight of the poly-D-lactic acid is not less than 2 and less than 30;

performing solid-state polymerization at a temperature lower than the melting point of the resulting mixture; and

adding the (B) cyclic compound containing a glycidyl group or acid anhydride to the mixture;

(II) a method of producing the polylactic acid resin composition, the method comprising:

mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000; or the ratio between the weight average molecular weight of the poly-L-lactic acid and the weight average molecular weight of the poly-D-lactic acid is not less than 2 and less than 30;

adding the (B) cyclic compound containing a glycidyl group or acid anhydride to the resulting mixture; and

performing solid-state polymerization at a temperature lower than the melting point of the mixture; or

(III) a method of producing the polylactic acid resin composition, the method comprising:

mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000, with the (B) cyclic compound containing a glycidyl group or acid anhydride; or mixing poly-L-lactic acid and poly-D-lactic acid, wherein the ratio between the weight average molecular weight of the poly-L-lactic acid and the weight average molecular weight of the poly-D-lactic acid is not less than 2 and less than 30, with the (B) cyclic compound containing a glycidyl group or acid anhydride; and

performing solid-state polymerization at a temperature lower than the melting point of the resulting mixture.

A polylactic acid resin composition having improved mechanical properties, durability, and heat resistance, as well as excellent wet heat properties and dry heat properties, can be provided. Since this polylactic acid resin comprises a polylactic acid block copolymer as a constituting component, the polylactic acid resin composition can have not only improved moldability and residence stability under heat, but also excellent wet heat properties and dry heat properties so that its molded articles can be applied not only to the conventional field of fibers, but also to a wide range of fields such as films and resin molded articles.

### DETAILED DESCRIPTION

Our compositions, molded products and methods are described below in detail. It should be noted that this disclosure is not limited to the examples described below.

### Polylactic Acid Block Copolymer

The polylactic acid block copolymer constituted by a poly-L-lactic acid segment(s) containing as a major component L-lactic acid and a poly-D-lactic acid segment(s) containing as a major component D-lactic acid means a polylactic acid block copolymer in which a segment(s) composed of L-lactic acid units and a segment(s) composed of D-lactic acid units are covalently bonded to each other.

The segment composed of L-lactic acid units herein is a polymer containing as a major component L-lactic acid, and means a polymer containing L-lactic acid units at not less than 70 mol %. The content of the L-lactic acid units is more preferably not less than 80 mol %, still more preferably not less than 90 mol %, especially preferably not less than 95 mol %, most preferably not less than 98 mol %.

The segment composed of D-lactic acid units herein is a polymer containing as a major component D-lactic acid, and means a polymer containing D-lactic acid units at not less than 70 mol %. The content of the D-lactic acid units is more preferably not less than 80 mol %, still more preferably not less than 90 mol %, especially preferably not less than 95 mol %, most preferably not less than 98 mol %.

The segment composed of L-lactic acid or D-lactic acid units may also contain other component units as long as the performance of the resulting polylactic acid block copolymer, or polylactic acid resin composition containing the polylactic acid block copolymer, is not deteriorated. Examples of the component units other than L-lactic acid and D-lactic acid units include polycarboxylic acid, polyalcohol, hydroxycarboxylic acid, and lactone, and specific examples of the component units include: polycarboxylic acids such as succinic acid, adipic acid, sebacic acid, fumaric acid, terephthalic acid, isophthalic acid, 2,6-naphthalenedicarboxylic acid, 5-sodium sulfoisophthalic acid, 5-tetrabutylphosphonium sulfoisophthalic acid, and derivatives thereof; polyalcohols such as ethylene glycol, propylene glycol, butanediol, pentanediol, hexanediol, octanediol, neopentyl glycol, glycerin, trimethylolpropane, pentaerythritol, polyalcohol prepared by addition of ethylene oxide or propylene oxide to trimethylolpropane or pentaerythritol, aromatic polyalcohol prepared by addition reaction of bisphenol with ethylene oxide, diethylene glycol, triethylene glycol, polyethylene glycol, and polypropylene glycol, and derivatives thereof; hydroxycarboxylic acids such as glycolic acid, 3-hydroxybutyric acid, 4-hydroxybutyric acid, 4-hydroxyvaleric acid, and 6-hydroxycaproic acid; and lactones such as glycolide, ε-caprolactone glycolide, ε-caprolactone, β-propiolactone, δ-butyrolactone, β- or γ-butyrolactone, pivalolactone, and δ-valerolactone.

Since stereocomplex formation allows the polylactic acid block copolymer to have a melting point derived from stereocomplex crystals of 190 to 230° C., the polylactic acid block copolymer has higher heat resistance compared to polylactic acid homopolymers. The melting point derived from stereocomplex crystals is preferably 200° C. to 230° C., more preferably 205° C. to 230° C., especially preferably 210° C. to 230° C. In addition, there may be a small melting peak(s) derived from crystals of poly-L-lactic acid alone and/or crystals of poly-D-lactic acid alone of 150° C. to 185° C.

Further, the polylactic acid block copolymer obtained has a degree of stereocomplexation (Sc) of 80% to 100% in view of the heat resistance. The degree of stereocomplexation is more preferably 85 to 100%, especially preferably 90 to 100%. The degree of stereocomplexation herein means the ratio of stereocomplex crystals with respect to the total crystals in the polylactic acid. More particularly, it can be calculated according to Equation (4), wherein ΔHl represents the heat of fusion of crystals of poly-L-lactic acid alone and crystals of poly-D-lactic acid alone, and ΔHh represents the heat of fusion of stereocomplex crystals, as measured by differential scanning calorimetry (DSC) by increasing the temperature from 30° C. to 250° C. at a heating rate of 20° C./min.

Sc=ΔHh/(ΔHl+ΔHh)×100 (4)

The polylactic acid block copolymer preferably further satisfies Inequality (5).

1<(Tm−Tms)/(Tme−Tm)<1.8 (5)

In this Inequality, Tm represents the melting point measured by differential scanning calorimetry (DSC) by increasing the temperature of the polylactic acid block copolymer at a heating rate of 40° C./min. from 30° C. to 250° C.; Tms represents the start of melting point measured by differential scanning calorimetry (DSC) by increasing the temperature of the polylactic acid block copolymer at a heating rate of 40° C./min. from 30° C. to 250° C.; and Tme represents the end of melting point measured by differential scanning calorimetry (DSC) by increasing the temperature of the polylactic acid block copolymer at a heating rate of 40° C./min. from 30° C. to 250° C. The range of 1<(Tm−Tms)/(Tme−Tm)<1.6 is preferred, and the range of 1<(Tm−Tms)/(Tme−Tm)<1.4 is more preferred.

The cooling crystallization temperature (Tc) is preferably not less than 130° C. in view of the moldability and the heat resistance of the polylactic acid block copolymer. The cooling crystallization temperature (Tc) of the molded product herein means the crystallization temperature derived from polylactic acid crystals measured by differential scanning calorimetry (DSC) by increasing the temperature at a heating rate of 20° C./min. from 30° C. to 250° C. and keeping the temperature constant for 3 minutes at 250° C., followed by decreasing the temperature at a cooling rate of 20° C./min. The crystallization temperature (Tc) is not restricted, and preferably not less than 130° C., more preferably not less than 132° C., especially preferably not less than 135° C. in view of the heat resistance and the transparency.

The weight average molecular weight of the polylactic acid block copolymer is preferably not less than 100,000 and less than 300,000 in view of the mechanical properties. The weight average molecular weight is more preferably not less than 120,000 and less than 280,000, still more preferably not less than 130,000 and less than 270,000, especially preferably not less than 140,000 and less than 260,000 in view of the moldability and the mechanical properties.

The polydispersity of the polylactic acid block copolymer is preferably 1.5 to 3.0 in view of the mechanical properties. The polydispersity is more preferably 1.8 to 2.7, especially preferably 2.0 to 2.4 in view of the moldability and the mechanical properties. The weight average molecular weight and the polydispersity are values which are measured by gel permeation chromatography (GPC) using as a solvent hexafluoroisopropanol or chloroform, and calculated in terms of a poly(methyl methacrylate) standard.

The average sequence length of the polylactic acid block copolymer is preferably not less than 20. The average sequence length is more preferably not less than 25, and an average sequence length of not less than 30 is especially preferred in view of the mechanical properties of the molded product. The average sequence length of the polylactic acid block copolymer can be calculated by ¹³C-NMR measurement according to Equation (6), wherein (a) represents the integrated value of the peak at about 170.1 to 170.3 ppm among the peaks of carbon belonging to carbonyl carbon, and (b) represents the integrated value of the peak at about 169.8 to 170.0 ppm.

Average sequence length=(a)/(b) (6)

The total number of the segment(s) composed of L-lactic acid units and the segment(s) composed of D-lactic acid units, contained in each molecule of the polylactic acid block copolymer is preferably not less than 3 in view of obtaining a polylactic acid block copolymer which easily forms a polylactic acid stereocomplex having a high melting point. The total number of these segments is more preferably not less than 5, especially preferably not less than 7.

The weight ratio between the total segment(s) composed of L-lactic acid units and the total segment(s) composed of D-lactic acid units is preferably 90:10 to 10:90. The weight ratio is more preferably 80:20 to 20:80, especially preferably 75:25 to 60:40, or 40:60 to 25:75. When the weight ratio between the total segment(s) composed of L-lactic acid units and the total segment(s) composed of D-lactic acid units is within the above-described preferred range, a polylactic acid stereocomplex is likely to be formed, resulting in a sufficiently large increase in the melting point of the polylactic acid block copolymer.

### Method of Preparing Polylactic Acid Block Copolymer

The method of producing the polylactic acid block copolymer is not restricted, and conventional methods of preparing polylactic acid may be used. Specific examples of the method include a lactide method wherein either one of cyclic dimer L-lactide or D-lactide produced from raw material lactic acid is subjected to ring-opening polymerization in the presence of a catalyst, and the lactide corresponding to the optical isomer of the polylactic acid is further added, followed by subjecting the resulting mixture to ring-opening polymerization, to obtain a polylactic acid block copolymer (Polylactic Acid Block Copolymer Preparation Method 1); a method wherein each of poly-L-lactic acid and poly-D-lactic acid is polymerized by direct polymerization of the raw material or by ring-opening polymerization via lactide, and the obtained poly-L-lactic acid and poly-D-lactic acid are then mixed, followed by obtaining a polylactic acid block copolymer by solid-state polymerization (Polylactic Acid Block Copolymer Preparation Method 2); a method wherein poly-L-lactic acid and poly-D-lactic acid are melt-mixed at a temperature of not less than the end of melting point of the component having a higher melting point for a long time to perform transesterification between the segment(s) of L-lactic acid units and the segment(s) of D-lactic acid units, to obtain a polylactic acid block copolymer (Polylactic Acid Block Copolymer Preparation Method 3); and a method wherein a polyfunctional compound(s) is/are mixed with poly-L-lactic acid and poly-D-lactic acid, and the reaction is allowed to proceed to cause covalent bonding of the poly-L-lactic acid and the poly-D-lactic acid by the polyfunctional compound(s), to obtain a polylactic acid block copolymer (Polylactic Acid Block Copolymer Preparation Method 4). Any of the production methods may be used, and the method by mixing poly-L-lactic acid and poly-D-lactic acid followed by solid-state polymerization is preferred since, in this method, the total number of the segment(s) composed of L-lactic acid units and the segment(s) composed of D-lactic acid units contained per one molecule of the polylactic acid block copolymer is not less than 3, and a polylactic acid block copolymer having all of excellent heat resistance, crystallinity, and mechanical properties can be obtained as a result.

The poly-L-lactic acid herein means a polymer containing L-lactic acid as a major component and containing not less than 70 mol % L-lactic acid units. The poly-L-lactic acid comprises preferably not less than 80 mol %, more preferably not less than 90 mol %, still more preferably not less than 95 mol %, especially preferably not less than 98 mol % L-lactic acid units.

The poly-D-lactic acid herein means a polymer containing D-lactic acid as a major component and containing not less than 70 mol % D-lactic acid units. The poly-D-lactic acid comprises preferably not less than 80 mol %, more preferably not less than 90 mol %, still more preferably not less than 95 mol %, especially preferably not less than 98 mol % D-lactic acid units.

Methods of preparation of a polylactic acid block copolymer are described below in detail.

Examples of the method wherein a polylactic acid block copolymer is obtained by ring-opening polymerization (Preparation Method 1) include a method wherein either one of L-lactide or D-lactide is subjected to ring-opening polymerization in the presence of a catalyst, and the lactide corresponding to the other optical isomer is added, followed by subjecting the resulting mixture to ring-opening polymerization, to obtain a polylactic acid block copolymer.

The ratio between the weight average molecular weight of the segment(s) composed of L-lactic acid units and the weight average molecular weight of the segment(s) composed of D-lactic acid units contained per one molecule of the polylactic acid block copolymer obtained by the ring-opening polymerization is preferably not less than 2 and less than 30 in view of the heat resistance, and the transparency of the molded product. The ratio is more preferably not less than 3 and less than 20, especially preferably not less than 5 and less than 15. The ratio between the weight average molecular weight of the segment(s) composed of L-lactic acid units and the weight average molecular weight of the segment(s) composed of D-lactic acid units can be controlled by the weight ratio between the L-lactide and the D-lactide used for the polymerization of the polylactic acid block copolymer.

The total number of the segment(s) composed of L-lactic acid units and segment(s) composed of D-lactic acid units contained per one molecule of the polylactic acid block copolymer obtained by the ring-opening polymerization is preferably not less than 3 in view of improvement of the heat resistance and the crystallinity. The total number is more preferably not less than 5, especially preferably not less than 7. The weight average molecular weight per segment is preferably 2000 to 50,000. The weight average molecular weight per segment is more preferably 4000 to 45,000, especially preferably 5000 to 40,000.

The optical purity of the L-lactide and the D-lactide to be used in the ring-opening polymerization method is preferably not less than 90% ee in view of improvement of the crystallinity and the melting point of the polylactic acid block copolymer. The optical purity is more preferably not less than 95% ee, especially preferably not less than 98% ee.

When a polylactic acid block copolymer is obtained by the ring-opening polymerization method, the amount of water in the reaction system is preferably not more than 4 mol % with respect to the total amount of L-lactide and D-lactide in view of obtaining a high molecular weight product. The amount of water is more preferably not more than 2 mol %, especially preferably not more than 0.5 mol %. The amount of water is a value measured by coulometric titration using the Karl-Fischer method.

Examples of the polymerization catalyst used to prepare the polylactic acid block copolymer by the ring-opening polymerization method include metal catalysts and acid catalysts. Examples of the metal catalysts include tin compounds, titanium compounds, lead compounds, zinc compounds, cobalt compounds, iron compounds, lithium compounds, and rare earth compounds. Preferred examples of the types of the compounds include metal alkoxides, halogen metal compounds, organic carboxylates, carbonates, sulfates, and oxides. Specific examples of the tin compounds include tin powder, tin(II) chloride, tin(IV) chloride, tin(II) bromide, tin(IV) bromide, ethoxytin(II), t-butoxytin(IV), isopropoxytin(IV), stannous acetate, tin(IV) acetate, stannous octoate, tin(II) laurate, tin(II) myristate, tin(II) palmitate, tin(II) stearate, tin(II) oleate, tin(II) linoleate, tin(II) acetylacetonate, tin(II) oxalate, tin(II) lactate, tin(II) tartrate, tin(II) pyrophosphate, tin(II) p-phenolsulfonate, tin(II) bis(methanesulfonate), tin(II) sulfate, tin(II) oxide, tin(IV) oxide, tin(II) sulfide, tin(IV) sulfide, dimethyltin(IV) oxide, methylphenyltin(IV) oxide, dibutyltin(IV) oxide, dioctyltin(IV) oxide, diphenyltin(IV) oxide, tributyltin oxide, triethyltin(IV) hydroxide, triphenyltin(IV) hydroxide, tributyltin hydride, monobutyltin(IV) oxide, tetramethyltin(IV), tetraethyltin(IV), tetrabutyltin(IV), dibutyldiphenyltin(IV), tetraphenyltin(IV), tributyltin(IV) acetate, triisobutyltin(IV) acetate, triphenyltin(IV) acetate, dibutyltin diacetate, dibutyltin dioctoate, dibutyltin(IV) dilaurate, dibutyltin(IV) maleate, dibutyltin bis(acetylacetonate), tributyltin(IV) chloride, dibutyltin dichloride, monobutyltin trichloride, dioctyltin dichloride, triphenyltin(IV) chloride, tributyltin sulfide, tributyltin sulfate, tin(II) methanesulfonate, tin(II) ethanesulfonate, tin(II) trifluoromethanesulfonate, ammonium hexachlorostannate(IV), dibutyltin sulfide, diphenyltin sulfide, triethyltin sulfate, and tin(II) phthalocyanine Specific examples of the titanium compounds include titanium methoxide, titanium propoxide, titanium isopropoxide, titanium butoxide, titanium isobutoxide, titanium cyclohexide, titanium phenoxide, titanium chloride, titanium diacetate, titanium triacetate, titanium tetraacetate, and titanium(IV) oxide. Specific examples of the lead compounds include diisopropoxylead(II), lead monochloride, lead acetate, lead(II) octoate, lead(II) isooctoate, lead(II) isononanoate, lead(II) laurate, lead(II) oleate, lead(II) linoleate, lead naphthenate, lead(II) neodecanoate, lead oxide, and lead(II) sulfate. Specific examples of the zinc compounds include zinc powder, methylpropoxy zinc, zinc chloride, zinc acetate, zinc(II) octoate, zinc naphthenate, zinc carbonate, zinc oxide, and zinc sulfate. Specific examples of the cobalt compounds include cobalt chloride, cobalt acetate, cobalt(II) octoate, cobalt(II) isooctoate, cobalt(II) isononanoate, cobalt(II) laurate, cobalt(II) oleate, cobalt(II) linoleate, cobalt naphthenate, cobalt(II) neodecanoate, cobalt(II) carbonate, cobalt(II) sulfate, and cobalt(II) oxide. Specific examples of the iron compounds include iron(II) chloride, iron(II) acetate, iron(II) octoate, iron naphthenate, iron(II) carbonate, iron(II) sulfate, and iron(II) oxide. Specific examples of the lithium compounds include lithium propoxide, lithium chloride, lithium acetate, lithium octoate, lithium naphthenate, lithium carbonate, dilithium sulfate, and lithium oxide. Specific examples of the rare earth compounds include triisopropoxyeuropium(III), triisopropoxyneodymium(III), triisopropoxylanthanum, triisopropoxysamarium(III), triisopropoxyyttrium, isopropoxyyttrium, dysprosium chloride, europium chloride, lanthanum chloride, neodymium chloride, samarium chloride, yttrium chloride, dysprosium(III) triacetate, europium(III) triacetate, lanthanum acetate, neodymium triacetate, samarium acetate, yttrium triacetate, dysprosium(III) carbonate, dysprosium(IV) carbonate, europium(II) carbonate, lanthanum carbonate, neodymium carbonate, samarium(II) carbonate, samarium(III) carbonate, yttrium carbonate, dysprosium sulfate, europium(II) sulfate, lanthanum sulfate, neodymium sulfate, samarium sulfate, yttrium sulfate, europium dioxide, lanthanum oxide, neodymium oxide, samarium(III) oxide, and yttrium oxide. Other examples of the metal catalysts include potassium compounds such as potassium isopropoxide, potassium chloride, potassium acetate, potassium octoate, potassium naphthenate, potassium t-butyl carbonate, potassium sulfate, and potassium oxide; copper compounds such as copper(II) diisopropoxide, copper(II) chloride, copper(II) acetate, copper octoate, copper naphthenate, copper(II) sulfate, and dicopper carbonate; nickel compounds such as nickel chloride, nickel acetate, nickel octoate, nickel carbonate, nickel(II) sulfate, and nickel oxide; zirconium compounds such as tetraisopropoxyzirconium(IV), zirconium trichloride, zirconium acetate, zirconium octoate, zirconium naphthenate, zirconium(II) carbonate, zirconium(IV) carbonate, zirconium sulfate, and zirconium(II) oxide; antimony compounds such as triisopropoxyantimony, antimony(III) fluoride, antimony(V) fluoride, antimony acetate, and antimony(III) oxide; magnesium compounds such as magnesium, magnesium diisopropoxide, magnesium chloride, magnesium acetate, magnesium lactate, magnesium carbonate, magnesium sulfate, and magnesium oxide; calcium compounds such as diisopropoxycalcium, calcium chloride, calcium acetate, calcium octoate, calcium naphthenate, calcium lactate, and calcium sulfate; aluminum compounds such as aluminum, aluminum isopropoxide, aluminum chloride, aluminum acetate, aluminum octoate, aluminum sulfate, and aluminum oxide; germanium compounds such as germanium, tetraisopropoxygermane, and germanium(IV) oxide; manganese compounds such as triisopropoxymanganese(III), manganese trichloride, manganese acetate, manganese(II) octoate, manganese(II) naphthenate, and manganese(II) sulfate; and bismuth compounds such as bismuth(III) chloride, bismuth powder, bismuth(III) oxide, bismuth acetate, bismuth octoate, and bismuth neodecanoate. Still other preferred examples of the metal catalysts include compounds composed of two or more kinds of metallic elements such as sodium stannate, magnesium stannate, potassium stannate, calcium stannate, manganese stannate, bismuth stannate, barium stannate, strontium stannate, sodium titanate, magnesium titanate, aluminum titanate, potassium titanate, calcium titanate, cobalt titanate, zinc titanate, manganese titanate, zirconium titanate, bismuth titanate, barium titanate, and strontium titanate.

The acid catalyst may be either a Brønsted acid as a proton donor or a Lewis acid as an electron-pair acceptor, and may be either an organic acid or an inorganic acid. Specific examples of the acid catalyst include monocarboxylic acid compounds such as formic acid, acetic acid, propionic acid, heptanoic acid, octanoic acid, octylic acid, nonanoic acid, isononanoic acid, trifluoroacetic acid, and trichloroacetic acid; dicarboxylic acid compounds such as oxalic acid, succinic acid, maleic acid, tartaric acid, and malonic acid; tricarboxylic acid compounds such as citric acid and tricarballylic acid; sulfonic acid compounds such as aromatic sulfonic acids including benzenesulfonic acid, n-butylbenzenesulfonic acid, n-octylbenzenesulfonic acid, n-dodecylbenzenesulfonic acid, pentadecylbenzenesulfonic acid, 2,5-dimethylbenzenesulfonic acid, 2,5-dibutylbenzenesulfonic acid, o-aminobenzenesulfonic acid, m-aminobenzenesulfonic acid, p-aminobenzenesulfonic acid, 3-amino 4-hydroxybenzenesulfonic acid, 5-amino-2-methylbenzenesulfonic acid, 3,5-diamino-2,4,6-trimethylbenzenesulfonic acid, 2,4-dinitrobenzenesulfonic acid, p-chlorobenzenesulfonic acid, 2,5-dichlorobenzenesulfonic acid, p-phenolsulfonic acid, cumene sulfonic acid, xylenesulfonic acid, o-cresolsulfonic acid, m-cresolsulfonic acid, p-cresolsulfonic acid, p-toluenesulfonic acid, 2-naphthalenesulfonic acid, 1-naphthalenesulfonic acid, isopropylnaphthalenesulfonic acid, dodecylnaphthalenesulfonic acid, dinonylnaphthalenesulfonic acid, dinonylnaphthalenedisulfonic acid, 1,5-naphthalenedisulfonic acid, 2,7-naphthalenedisulfonic acid, 4,4-biphenyldisulfonic acid, anthraquinone-2-sulfonic acid, m-benzenedisulfonic acid, 2,5-diamino-1,3-benzenedisulfonic acid, aniline-2,4-disulfonic acid, anthraquinone-1,5-disulfonic acid, and polystyrene sulfonic acid, aliphatic sulfonic acids including methanesulfonic acid, ethanesulfonic acid, 1-propanesulfonic acid, n-octylsulfonic acid, pentadecylsulfonic acid, trifluoromethanesulfonic acid, trichloromethanesulfonic acid, 1,2-ethanedisulfonic acid, 1,3-propanedisulfonic acid, aminomethanesulfonic acid, and 2-aminoethanesulfonic acid, and alicyclic sulfonic acids including cyclopentanesulfonic acid, cyclohexanesulfonic acid, camphorsulfonic acid, and 3-cyclohexylaminopropanesulfonic acid; acidic amino acids such as aspartic acid and glutamic acid; ascorbic acid; retinoic acid; phosphoric acid compounds such as phosphoric acid, metaphosphoric acid, phosphorous acid, hypophosphorous acid, polyphosphoric acid, phosphoric acid monoesters including monododecyl phosphate and monooctadecyl phosphate, phosphoric acid diesters including didodecyl phosphate and dioctadecyl phosphate, phosphorous acid monoesters, and phosphorous acid diesters; boric acid; hydrochloric acid; and sulfuric acid. The form of the acid catalyst is not restricted, and may be either a solid acid catalyst or a liquid acid catalyst. Examples of the solid acid catalyst include natural minerals such as acid clay, kaolinite, bentonite, montmorillonite, talc, zirconium silicate, and zeolite; oxides such as silica, alumina, titania, and zirconia; oxide complexes such as silica alumina, silica magnesia, silica boria, alumina boria, silica titania and silica zirconia; chlorinated alumina; fluorinated alumina; and positive ion exchange resins.

In consideration of the molecular weight of the polylactic acid produced by the ring-opening polymerization method, the polymerization catalyst for the ring-opening polymerization method is preferably a metal catalyst, and among metal catalysts, tin compounds, titanium compounds, antimony compounds, and rare earth compounds are more preferred. In consideration of the melting point of the polylactic acid produced by the ring-opening polymerization method, tin compounds and titanium compounds are more preferred. In consideration of the thermal stability of the polylactic acid produced by the ring-opening polymerization method, tin-based organic carboxylates and tin-based halogen compounds are preferred, and stannous acetate, stannous octoate and tin(II) chloride are more preferred.

The amount of the polymerization catalyst to be added in the ring-opening polymerization method is preferably 0.001 part by weight to 2 parts by weight, more preferably 0.001 part by weight to 1 part by weight with respect to 100 parts by weight of the material to be used (L-lactic acid, D-lactic acid, and/or the like). When the amount of the catalyst is within the preferred range, an effect to reduce the polymerization time can be obtained, and the molecular weight of the polylactic acid block copolymer finally obtained tends to be large. When not less than 2 kinds of catalysts are used in combination, the total amount of the catalysts to be added is preferably within the range described above.

The timing of addition of the polymerization catalyst in the ring-opening polymerization method is not limited and, from the viewpoint of uniformly dispersing the catalyst in the system and thereby increasing the polymerization activity, it is preferred to melt the lactide under heat, followed by adding the catalyst.

The method in which poly-L-lactic acid and poly-D-lactic acid are mixed together, followed by obtaining a polylactic acid block copolymer by solid-state polymerization (Preparation Method 2) is described below. In this preparation method, either the ring-opening polymerization method or direct polymerization method may be used for the polymerization of poly-L-lactic acid and poly-D-lactic acid.

When poly-L-lactic acid and poly-D-lactic acid are mixed together, followed by preparing a polylactic acid block copolymer by solid-state polymerization, either one of the poly-L-lactic acid and the poly-D-lactic acid preferably has a weight average molecular weight of 60,000 to 300,000, and the other preferably has a weight average molecular weight of 10,000 to 100,000, from the viewpoint of achieving a high weight average molecular weight and degree of stereocomplexation after the solid-state polymerization. More preferably, one of the poly-L-lactic acid and the poly-D-lactic acid has a weight average molecular weight of 100,000 to 270,000, and the other has a weight average molecular weight of 15,000 to 80,000. Especially preferably, one of the poly-L-lactic acid and the poly-D-lactic acid has a weight average molecular weight of 150,000 to 240,000, and the other has a weight average molecular weight of 20,000 to 50,000. In another preferred example in terms of weight average molecular weights of the poly-L-lactic acid component and the poly-D-lactic acid component, either one of the poly-L-lactic acid and the poly-D-lactic acid has a weight average molecular weight of 120,000 to 300,000, and the other has a weight average molecular weight of 30,000 to 100,000. More preferably, one of the poly-L-lactic acid and the poly-D-lactic acid has a weight average molecular weight of 100,000 to 270,000, and the other has a weight average molecular weight of 35,000 to 80,000. Still more preferably, one of the poly-L-lactic acid and the poly-D-lactic acid has a weight average molecular weight of 125,000 to 255,000, and the other has a weight average molecular weight of 25,000 to 50,000.

Preferably, the combination of the weight average molecular weights of the poly-L-lactic acid and the poly-D-lactic acid is appropriately selected such that the weight average molecular weight of the resulting mixture is not less than 90,000.

In terms of poly-L-lactic acid and poly-D-lactic acid, the ratio between the polylactic acid having a higher weight average molecular weight and the polylactic acid having a lower weight average molecular weight is preferably not less than 2 and less than 30. The ratio is more preferably not less than 3 and less than 20, most preferably not less than 5 and less than 15. Preferably, the combination of the weight average molecular weights of the poly-L-lactic acid and the poly-D-lactic acid is selected such that the weight average molecular weight of the resulting mixture is not less than 90,000.

The poly-L-lactic acid and the poly-D-lactic acid preferably satisfy both of the following conditions: the weight average molecular weights of the poly-L-lactic acid component and the poly-D-lactic acid component are within the range described above; and the ratio between the weight average molecular weights of the poly-L-lactic acid component and the poly-D-lactic acid component is not less than 2 and less than 30.

The weight average molecular weight herein is a value which is measured by gel permeation chromatography (GPC) using as a solvent hexafluoroisopropanol or chloroform, and calculated in terms of a poly(methyl methacrylate) standard.

Each of the amount of lactide and the amount of oligomers contained in the poly-L-lactic acid or the poly-D-lactic acid is preferably not more than 5%. The amount is more preferably not more than 3%, especially preferably not more than 1%. The amount of lactic acid contained in the poly-L-lactic acid or the poly-D-lactic acid is preferably not more than 2%. The amount is more preferably not more than 1%, especially preferably not more than 0.5%.

In terms of acid values of the poly-L-lactic acid and the poly-D-lactic acid, the acid value of either one of the poly-L-lactic acid and the poly-D-lactic acid is preferably not more than 100 eq/ton. The value is more preferably not more than 50 eq/ton, still more preferably not more than 30 eq/ton, especially preferably not more than 15 eq/ton. The acid value of the other of the poly-L-lactic acid and the poly-D-lactic acid to be mixed is preferably not more than 600 eq/ton. The value is more preferably not more than 300 eq/ton, still more preferably not more than 150 eq/ton, especially preferably not more than 100 eq/ton.

In the method wherein the ring-opening polymerization method is used for polymerization of poly-L-lactic acid or poly-D-lactic acid, the amount of water in the reaction system is preferably not more than 4 mol % with respect to the total amount of L-lactide and D-lactide in view of obtaining a high molecular weight product. The amount of water is more preferably not more than 2 mol %, especially preferably not more than 0.5 mol %. The amount of water is a value measured by coulometric titration using the Karl-Fischer method.

Examples of the polymerization catalyst for the production of poly-L-lactic acid or poly-D-lactic acid by the ring-opening polymerization include the metal catalysts and the acid catalysts mentioned for Preparation Method 1.

The amount of the polymerization catalyst to be added in the ring-opening polymerization method is preferably 0.001 part by weight to 2 parts by weight, especially preferably 0.001 part by weight to 1 part by weight with respect to 100 parts by weight of the raw materials used (L-lactic acid, D-lactic acid and/or the like). When the amount of the catalyst is within the above-described preferred range, the effect of reducing the polymerization time can be obtained, and the molecular weight of the polylactic acid block copolymer finally obtained tends to be high. When two or more types of catalysts are used in combination, the total amount of the catalysts added is preferably within the above-described range.

The timing of addition of the polymerization catalyst in the ring-opening polymerization method is not restricted, and the catalyst is preferably added after melting of the lactide under heat in view of uniform dispersion of the catalyst in the system and enhancement of the polymerization activity.

Examples of the polymerization catalyst used for production of the poly-L-lactic acid or the poly-D-lactic acid by the direct polymerization method include metal catalysts and acid catalysts. Examples of the metal catalysts include tin compounds, titanium compounds, lead compounds, zinc compounds, cobalt compounds, iron compounds, lithium compounds, and rare earth compounds. Preferred examples of the types of the compounds include metal alkoxides, halogen metal compounds, organic carboxylates, carbonates, sulfates, and oxides. Specific examples of the metal catalysts include the metal compounds described for Preparation Method 1, and specific examples of the acid catalysts include the acid compounds described for Preparation Method 1.

In consideration of the molecular weight of the polylactic acid produced by the direct polymerization method, tin compounds, titanium compounds, antimony compounds, rare earth compounds, and acid catalysts are preferred and, in consideration of the melting point of the produced polylactic acid, tin compounds, titanium compounds, and sulfonic acid compounds are more preferred. Further, in view of the thermal stability of the produced polylactic acid, in the case of a metal catalyst, tin-based organic carboxylates and tin-based halogen compounds are preferred, and stannous acetate, stannous octoate, and tin(II) chloride are more preferred; and, in the case of an acid catalyst, mono- and disulfonic acid compounds are preferred, and methanesulfonic acid, ethanesulfonic acid, propanesulfonic acid, propanedisulfonic acid, naphthalenedisulfonic acid, and 2-aminoethanesulfonic acid are more preferred. The catalyst may be of a single type, or two or more types of catalysts may be used in combination. In view of enhancement of the polymerization activity, two or more types of catalysts are preferably used in combination. In view of also allowing suppression of coloring, one or more selected from tin compounds and/or one or more selected from sulfonic acid compounds is/are preferably used. In view of achievement of excellent productivity, it is preferred to employ stannous acetate and/or stannous octoate in combination with any one or more of methanesulfonic acid, ethanesulfonic acid, propanedisulfonic acid, naphthalenedisulfonic acid, and 2-aminoethanesulfonic acid, and it is more preferred to employ stannous acetate and/or stannous octoate in combination with any one of methanesulfonic acid, ethanesulfonic acid, propanedisulfonic acid, and 2-aminoethanesulfonic acid.

The amount of the polymerization catalyst to be added is preferably 0.001 part by weight to 2 parts by weight, more preferably 0.001 part by weight to 1 part by weight with respect to 100 parts by weight of the raw materials used (L-lactic acid, D-lactic acid and/or the like). When the amount of the catalyst is within the preferred range, the polymerization time can be shortened and, the molecular weight of the polylactic acid block copolymer finally obtained can be increased. When two or more types of catalysts are used in combination, the total amount of the catalysts added is preferably within the above-described range. When one or more selected from tin compounds and/or one or more selected from sulfonic acid compounds are used in combination, the weight ratio between the tin compound(s) and the sulfonic acid compound(s) is preferably 1:1 to 1:30 in view of maintenance of high polymerization activity and suppression of coloring, and is preferably 1:2 to 1:15 in view of achievement of excellent productivity.

The timing of addition of the polymerization catalyst is not restricted and, especially when the polylactic acid is polymerized by the direct polymerization method, an acid catalyst is preferably added to the raw material or before dehydration of the raw material in view of achievement of excellent productivity. A metal catalyst is preferably added after dehydration of the raw material in view of increasing the polymerization activity.

When the polylactic acid block copolymer is obtained by mixing the poly-L-lactic acid and the poly-D-lactic acid and then performing solid-state polymerization, the poly-L-lactic acid and the poly-D-lactic acid are preferably mixed such that the degree of stereocomplexation (Sc) immediately before the solid-state polymerization exceeds 60%. The degree of stereocomplexation is more preferably 70% to 99%, especially preferably 80% to 95%. That is, according to Equation (4), the degree of stereocomplexation (Sc) preferably satisfies Equation (2).

Sc=ΔHh/(ΔHl−ΔHh)×100>60 (2)

In this Equation,

ΔHh: the heat of fusion of stereocomplex crystals (J/g) in DSC measurement of the mixture of poly-L-lactic acid and poly-D-lactic acid, wherein the temperature is increased at a heating rate of 20° C./min.; and

ΔHl: the heat of fusion of crystals (J/g) of poly-L-lactic acid alone and crystals of poly-D-lactic acid alone in DSC measurement of the mixture of poly-L-lactic acid and poly-D-lactic acid, wherein the temperature is increased at a heating rate of 20° C./min.

Whether or not the poly-L-lactic acid and the poly-D-lactic acid to be used for the mixing are crystallized is not restricted, and poly-L-lactic acid and poly-D-lactic acid in the crystallized state may be mixed together, or poly-L-lactic acid and poly-D-lactic acid in the molten state may be mixed together. When crystallization of the poly-L-lactic acid and the poly-D-lactic acid to be used for the mixing is carried out, specific examples of the method thereof include a method wherein the polylactic acids are maintained at a crystallization treatment temperature in the gas phase or liquid phase, a method wherein poly-L-lactic acid and poly-D-lactic acid in the molten state are retained in a melting apparatus at a temperature between the melting point−50° C. and the melting point+20° C. under shearing, and a method wherein poly-L-lactic acid and poly-D-lactic acid in the molten state are retained in a melting apparatus at a temperature between the melting point−50° C. and the melting point+20° C. under pressure.

The crystallization treatment temperature herein is not restricted as long as the temperature is higher than the glass-transition temperature and lower than the melting point of the polylactic acid having a lower melting point, which is selected between the poly-L-lactic acid and the poly-D-lactic acid mixed as described above. The crystallization treatment temperature is more preferably between the heating crystallization temperature and the cooling crystallization temperature as measured by differential scanning calorimetry (DSC) in advance.

The crystallization in the gas phase or liquid phase may be carried out under any of the conditions of reduced, normal and increased pressures.

In terms of crystallization period in the gas phase or liquid phase, sufficient crystallization can be achieved within 3 hours, and a period of not more than 2 hours is also preferred.

In the above-described method wherein poly-L-lactic acid and poly-D-lactic acid are crystallized under shearing or pressure in a melting apparatus, the melting apparatus is not restricted as long as the shearing or pressurization is possible therewith. Examples of the melting apparatus which may be used include polymerization reactors, kneaders, Banbury mixer, single screw extruders, twin screw extruders, and injection molding machines. The melting apparatus is preferably a single screw extruder or a twin screw extruder.

In the method wherein crystallization is carried out in a melting apparatus under shearing or pressure, the crystallization treatment temperature is preferably between the melting point−50° C. and the melting point+20° C. of the poly-L-lactic acid and the poly-D-lactic acid to be mixed. The crystallization temperature is more preferably between the melting point−40° C. and the melting point, especially preferably between the melting point−30° C. and the melting point-5° C. The temperature of the melting apparatus is normally set to a temperature of not less than the melting point+20° C. for melting the resin to allow achievement of good fluidity, but, when the temperature of the melting apparatus is set within the above-described preferred range, crystallization proceeds while appropriate fluidity is maintained, and produced crystals are less likely to be remelted. The melting point herein means the crystal melting temperature measured by differential scanning calorimetry by increasing the temperature from 30° C. to 250° C. at a heating rate of 20° C./min.

The crystallization treatment time is preferably 0.1 minute to 10 minutes, more preferably 0.3 to 5 minutes, especially preferably 0.5 minute to 3 minutes. When the crystallization treatment time is within the preferred range, crystallization sufficiently occurs, and thermal degradation is less likely to occur.

The molecules in molten resin tend to be oriented under shearing in the melting apparatus, and this allows a remarkable increase in the crystallization rate as a result. The shear rate in this step is preferably 10 to 400 (/second). When the shear rate is within the preferred range, the crystallization rate is sufficiently large, and thermal degradation due to shear heating is less likely to occur.

Crystallization tends to be promoted also under pressure, and the pressure is especially preferably 0.05 to 10 (MPa) in view of obtaining crystallized polylactic acid having both favorable fluidity and crystallinity. When the pressure is within the preferred range, the crystallization rate is sufficiently high.

When both shearing at a shear rate of 10 to 400 (/second) and a pressure of 0.05 to 10 (MPa) are given during the treatment, the crystallization rate is even higher, which is especially preferred.

The method of mixing poly-L-lactic acid and poly-D-lactic acid is not restricted, and examples of the method include a method wherein poly-L-lactic acid and poly-D-lactic acid are melt-mixed at a temperature of not less than the end of melting point of the component having a higher melting point, a method wherein mixing in a solvent is followed by removal of the solvent, and a method wherein at least one of poly-L-lactic acid and poly-D-lactic acid in the molten state is retained in a melting apparatus at a temperature between the melting point−50° C. and the melting point+20° C. under shearing, followed by mixing such that crystals of the mixture composed of poly-L-lactic acid and poly-D-lactic acid remain.

The melting point herein means the temperature at the peak top of the peak due to melting of crystals of polylactic acid alone as measured by differential scanning calorimetry (DSC), and the end of melting point means the temperature at the end of the peak due to melting of crystals of polylactic acid alone as measured by differential scanning calorimetry (DSC).

Examples of the method wherein melt mixing is performed at a temperature of not less than the end of melting point include a method wherein poly-L-lactic acid and poly-D-lactic acid are mixed either by a batch method or by a continuous method. Examples of the extruder include single screw extruders, twin screw extruders, plastomill, kneaders, and stirred tank reactors equipped with a pressure reducing device. In view of enabling uniform and sufficient kneading, a single screw extruder or a twin screw extruder is preferably used.

In terms of temperature conditions for melt mixing at a temperature of not less than the end of melting point, poly-L-lactic acid and poly-D-lactic acid are preferably melt-mixed at a temperature of not less than the end of melting point of the component having a higher melting point. The temperature is preferably 140° C. to 250° C., more preferably 160° C. to 230° C., especially preferably 180° C. to 210° C. When the mixing temperature is within the preferred range, the mixing can be carried out in the molten state, and the molecular weight is less likely to decrease during the mixing. Further, the fluidity of the mixture can be kept constant, and a remarkable decrease in the fluidity is less likely to occur.

In terms of time conditions for mixing, the mixing time is preferably 0.1 minute to 10 minutes, more preferably 0.3 minute to 5 minutes, especially preferably 0.5 minute to 3 minutes. When the mixing time is within the preferred range, poly-L-lactic acid and poly-D-lactic acid can be uniformly mixed, and thermal degradation due to mixing is less likely to occur.

The pressure conditions for the mixing at a temperature of not less than the end of melting point is not restricted, and the mixing may be carried out either in the air or under an atmosphere of an inert gas such as nitrogen.

Specific examples of the method of mixing the poly-L-lactic acid and the poly-D-lactic acid crystallized in a melting apparatus under shearing and/or pressure include mixing by a batch method or continuous method, and either method may be used for the mixing. The degree of stereocomplexation (Sc) of the mixture of poly-L-lactic acid and poly-D-lactic acid after mixing can be controlled by a method wherein poly-L-lactic acid and poly-D-lactic acid in the molten state are retained in a melting apparatus under shearing at a temperature between the melting point−50° C. and the melting point+20° C. of the polylactic acid having a lower melting point, or by a method wherein poly-L-lactic acid and poly-D-lactic acid in the molten state are retained in a melting apparatus under pressure at a temperature between the melting point−50° C. and the melting point+20° C. of the polylactic acid having a lower melting point. The degree of stereocomplexation (Sc) can be calculated according to Equation (4) described above.

The temperature during the mixing is preferably between the melting point−50° C. and the melting point+20° C. of the mixture of poly-L-lactic acid and poly-D-lactic acid. The mixing temperature is more preferably between the melting point−40° C. and the melting point, especially preferably between the melting point−30° C. and the melting point−5° C. The temperature of the melting apparatus is normally preferably set to a temperature of not less than the melting point+20° C. for achievement of good fluidity by melting of the resin. When the mixing temperature is set to such a preferred temperature, the fluidity does not decrease too much, and produced crystals are less likely to be remelted. The melting point herein means the crystal melting temperature measured by differential scanning calorimetry (DSC) by increasing the temperature from 30° C. to 250° C. at a heating rate of 20° C./min.

The poly-L-lactic acid and the poly-D-lactic acid crystallized in a melting apparatus under shearing and/or pressure are preferably mixed at a shear rate of 10 to 400 (/second). When the shear rate is within the preferred range, the poly-L-lactic acid and the poly-D-lactic acid can be uniformly mixed while the fluidity and crystallinity are maintained, and thermal degradation due to shear heating is less likely to occur during the mixing.

The pressure to be applied during the mixing is preferably 0.05 to 10 (MPa). When the pressure is within the preferred range, the poly-L-lactic acid and the poly-D-lactic acid can be uniformly mixed while the fluidity and crystallinity are maintained.

In kneading using an extruder, the method of supplying the polylactic acid is not restricted, and examples of possible methods thereof include a method wherein the poly-L-lactic acid and the poly-D-lactic acid are supplied at once from a resin hopper, and a method wherein, using a side resin hopper as required, each of the poly-L-lactic acid and the poly-D-lactic acid is separately supplied via a resin hopper or the side resin hopper. The polylactic acid may also be supplied in the molten state to the extruder directly after the step of producing the polylactic acid.

The screw element of the extruder is preferably equipped with a kneading element in the mixing section such that the poly-L-lactic acid and the poly-D-lactic acid can be uniformly mixed to form a stereocomplex.

In the mixing step, the mixing weight ratio between the poly-L-lactic acid composed of L-lactic acid units and the poly-D-lactic acid composed of D-lactic acid units is preferably 90:10 to 10:90. The mixing weight ratio is more preferably 80:20 to 20:80, especially preferably 75:25 to 60:40, or 40:60 to 25:75. When the weight ratio between the total segment(s) composed of L-lactic acid units and the total segment(s) composed of D-lactic acid units is within the above-described preferred range, a polylactic acid stereocomplex is likely to be formed, resulting in a sufficient increase in the melting point of the polylactic acid block copolymer. When the mixing weight ratio between the poly-L-lactic acid and the poly-D-lactic acid is other than 50:50, the mixing is preferably carried out such that the polylactic acid having a higher weight average molecular weight than the other, which is selected between the poly-L-lactic acid and the poly-D-lactic acid, is contained in a larger amount.

In this mixing step, it is preferred to include a catalyst in the mixture to efficiently promote the subsequent solid-state polymerization. The catalyst may be the residual component(s) of the catalyst(s) used for producing the poly-L-lactic acid and/or the poly-D-lactic acid. Additionally, one or more selected from the above-described catalysts may be added in the mixing step.

In view of efficiently promoting the solid-state polymerization, the content of the catalyst is preferably 0.001 part by weight to 1 part by weight, especially preferably 0.001 part by weight to 0.5 part by weight with respect to 100 parts by weight of the mixture of poly-L-lactic acid and poly-D-lactic acid. When the amount of the catalyst is within the above-described preferred range, the reaction time of the solid-state polymerization can be effectively reduced, and the molecular weight of the polylactic acid block copolymer finally obtained tends to be high.

The weight average molecular weight (Mw) of the mixture of poly-L-lactic acid and poly-D-lactic acid after the mixing is preferably not less than 90,000 and less than 300,000 in view of the mechanical properties of the mixture. The weight average molecular weight is more preferably not less than 120,000 and less than 300,000, especially preferably not less than 140,000 and less than 300,000.

The polydispersity of the mixture of poly-L-lactic acid and poly-D-lactic acid after the mixing is preferably 1.5 to 4.0. The polydispersity is more preferably 2.0 to 3.7, especially preferably 2.5 to 3.5. The polydispersity herein means the ratio of the weight average molecular weight to the number average molecular weight of the mixture, and is more particularly a value which is measured by gel permeation chromatography (GPC) using as a solvent hexafluoroisopropanol or chloroform, and calculated in terms of a poly(methyl methacrylate) standard.

Each of the amount of lactide and the amount of oligomers contained in the poly-L-lactic acid or poly-D-lactic acid is preferably not more than 5%. The amount is more preferably not more than 3%, especially preferably not more than 1%. The amount of lactic acid contained in the poly-L-lactic acid or poly-D-lactic acid is preferably not more than 2%. The amount is more preferably not more than 1%, especially preferably not more than 0.5%.

When the mixture is subjected to solid-state polymerization, the form of the mixture of poly-L-lactic acid and poly-D-lactic acid is not restricted, and the mixture may be in the form of a block(s), film(s), pellet(s), powder or the like. In view of efficient promotion of the solid-state polymerization, a pellet(s) or powder is/are preferably used. Examples of the method of forming the mixture of poly-L-lactic acid and poly-D-lactic acid into a pellet(s) include a method wherein the mixture is extruded into a strand-like shape and pelletized, and a method wherein the mixture is extruded into water and pelletized using an underwater cutter. Examples of the method of forming the mixture of poly-L-lactic acid and poly-D-lactic acid into powder include a method wherein the mixture is pulverized using a pulverizer such as a mixer, blender, ball mill, or hammer mill. The method of carrying out the solid-state polymerization step is not restricted, and either a batch method or continuous method may be employed. The reactor may be a stirring-vessel-type reactor, mixer-type reactor, column reactor, or the like, or two or more types of these reactors may be used in combination.

When this solid-state polymerization step is carried out, the mixture of poly-L-lactic acid and poly-D-lactic acid is preferably crystallized. When the mixture obtained by the step of mixing poly-L-lactic acid and poly-D-lactic acid is in the crystallized state, crystallization of the mixture of poly-L-lactic acid and poly-D-lactic acid is not necessarily required for carrying out the solid-state polymerization, but performing crystallization allows further enhancement of the efficiency of the solid-state polymerization.

The method of crystallization is not restricted, and a known method may be employed. Examples of the method include a method by maintaining the polylactic acid at a crystallization treatment temperature in the gas phase or liquid phase and a method by cooling and solidifying a molten mixture of poly-L-lactic acid and poly-D-lactic acid while carrying out the operation of stretching or shearing. In view of simplicity of the operation, the method by maintaining the polylactic acid at a crystallization treatment temperature in the gas phase or liquid phase is preferred.

The crystallization treatment temperature herein is not restricted as long as the temperature is higher than the glass-transition temperature and lower than the melting point of the polylactic acid having a lower melting point, which is selected between the poly-L-lactic acid and the poly-D-lactic acid in the mixture. The crystallization treatment temperature is more preferably between the heating crystallization temperature and the cooling crystallization temperature preliminarily measured by differential scanning calorimetry (DSC).

The crystallization may be carried out under any of the conditions of reduced, normal, and increased pressures.

In terms of period of the crystallization, the crystallization can be sufficiently achieved within 3 hours, and a period of not more than 2 hours is also preferred.

In terms of temperature conditions for carrying out the solid-state polymerization step, a temperature of not more than the melting point of the mixture of poly-L-lactic acid and poly-D-lactic acid is preferred. Since the mixture of poly-L-lactic acid and poly-D-lactic acid has a melting point of 190° C. to 230° C. derived from stereocomplex crystals due to stereocomplex formation and a melting point of 150° C. to 185° C. derived from crystals of poly-L-lactic acid alone and crystals of poly-D-lactic acid alone, the solid-state polymerization is preferably carried out at a temperature lower than these melting points. More specifically, the temperature is preferably not less than 100° C. and not more than 220° C., and, in view of efficiently promoting the solid-state polymerization, the temperature is more preferably not less than 110° C. and not more than 200° C., still more preferably not less than 120° C. and not more than 180° C., especially preferably not less than 130° C. and not more than 170° C.

To reduce the reaction time of the solid-state polymerization, the temperature is preferably increased stepwise or continuously as the reaction proceeds. The temperature conditions to increase the temperature stepwise during the solid-state polymerization are preferably 120° C. to 145° C. for 1 to 15 hours in the first step, 135° C. to 160° C. for 1 to 15 hours in the second step, and 150° C. to 175° C. for 10 to 30 hours in the third step; more preferably 130° C. to 145° C. for 2 to 12 hours in the first step, 140° C. to 160° C. for 2 to 12 hours in the second step, and 155° C. to 175° C. for 10 to 25 hours in the third step. In terms of temperature conditions to increase the temperature continuously during the solid-state polymerization, the temperature is preferably increased from an initial temperature of 130° C. to 150° C. to a temperature of 150° C. to 175° C. continuously at a heating rate of 1 to 5 (° C./min.). Combination of the stepwise temperature increase and the continuous temperature increase is also preferred in view of efficient promotion of the solid-state polymerization.

When the solid-state polymerization step is carried out, the step is preferably performed under vacuum or under the flow of an inert gas such as dry nitrogen. The degree of vacuum during the solid-state polymerization under vacuum is preferably not more than 150 Pa, more preferably not more than 75 Pa, especially preferably not more than 20 Pa. The flow rate during the solid-state polymerization under the flow of an inert gas is preferably 0.1 to 2000 (mL/min.), more preferably 0.5 to 1000 (mL/min.), especially preferably 1.0 to 500 (mL/min.), per 1 g of the mixture.

The yield of the polymer after the solid-state polymerization (Y) is preferably not less than 90%. The yield is more preferably not less than 93%, especially preferably not less than 95%. The yield of the polymer (Y) herein means the ratio of the weight of the polylactic acid block copolymer after the solid-state polymerization to the weight of the mixture before the solid-state polymerization. More specifically, the yield of the polymer (Y) can be calculated according to Equation (7), wherein Wp represents the weight of the mixture before the solid-state polymerization, and Ws represents the weight of the polymer after the solid-state polymerization.

Y=Ws/Wp×100 (7)

In the solid-state polymerization step, the polydispersity of the mixture preferably decreases. More specifically, the polydispersity preferably decreases such that the polydispersity of the mixture before the solid-state polymerization is 1.5 to 4.0, and the polydispersity of the polylactic acid block copolymer after the solid-state polymerization is 1.5 to 2.7. The polydispersity more preferably decreases such that the polydispersity of the mixture before the solid-state polymerization is 2.0 to 3.7, and the polydispersity of the polylactic acid block copolymer after the solid-state polymerization is 1.8 to 2.6. The polydispersity especially preferably decreases such that the polydispersity of the mixture before the solid-state polymerization is 2.5 to 3.5, and the polydispersity of the polylactic acid block copolymer after the solid-state polymerization is 2.0 to 2.5.

The method wherein poly-L-lactic acid and poly-D-lactic acid are melt-mixed at a temperature of not less than the end of melting point of the component having a higher melting point for a long time to perform transesterification between the segment(s) of L-lactic acid units and the segment(s) of D-lactic acid units, to obtain a polylactic acid block copolymer (Preparation Method 3) is described below. Also in this preparation method, either the ring-opening polymerization method or the direct polymerization method may be used for the polymerization of poly-L-lactic acid and poly-D-lactic acid.

To obtain a polylactic acid block copolymer by this method, one of the poly-L-lactic acid and the poly-D-lactic acid preferably has a weight average molecular weight of 60,000 to 300,000, and the other preferably has a weight average molecular weight of 10,000 to 100,000 in view of achieving a high degree of stereocomplexation after melt mixing. More preferably, one of the polylactic acids has a weight average molecular weight of 100,000 to 270,000, and the other has a weight average molecular weight of 15,000 to 80,000. Especially preferably, one of the polylactic acids has a weight average molecular weight of 150,000 to 240,000 and the other has a weight average molecular weight of 20,000 to 50,000. The combination of the weight average molecular weights of the poly-L-lactic acid and the poly-D-lactic acid is preferably appropriately selected such that the weight average molecular weight after mixing is not less than 90,000.

In another preferred mode, one of the poly-L-lactic acid and the poly-D-lactic acid preferably has a weight average molecular weight of 60,000 to 300,000, and the other preferably has a weight average molecular weight of 30,000 to 100,000 in view of achieving high mechanical properties of the polylactic acid resin composition after melt mixing. More preferably, one of the polylactic acids has a weight average molecular weight of 100,000 to 270,000, and the other has a weight average molecular weight of 20,000 to 80,000. Still more preferably, one of the polylactic acids has a weight average molecular weight of 125,000 to 255,000, and the other has a weight average molecular weight of 25,000 to 50,000.

Examples of the method of melt-mixing at a temperature of not less than the end of melting point for a long time include a method wherein poly-L-lactic acid and poly-D-lactic acid are mixed either by a batch method or by a continuous method. Examples of the extruder include single screw extruders, twin screw extruders, plastomill, kneaders, and stirred tank reactors equipped with a pressure reducing device. In view of enabling uniform and sufficient kneading, a single screw extruder or a twin screw extruder is preferably used.

In terms of temperature conditions for the mixing, it is important to carry out the mixing at a temperature of not less than the end of melting point of the component having a higher melting point, which is selected between the poly-L-lactic acid and the poly-D-lactic acid. The temperature is preferably 140° C. to 250° C., more preferably 160° C. to 230° C., especially preferably 180° C. to 210° C. When the mixing temperature is within the above-described preferred range, the fluidity does not decrease too much, and the molecular weight of the mixture is less likely to decrease.

In terms of time conditions for the mixing, the length of time is preferably 0.1 to 30 minutes, more preferably 0.3 to 20 minutes, especially preferably 0.5 to 10 minutes. When the mixing time is within the above-described preferred range, the poly-L-lactic acid and the poly-D-lactic acid can be uniformly mixed, and thermal degradation is less likely to occur by the mixing.

The pressure conditions during the mixing are not restricted, and the mixing may be carried out either in the air or under an atmosphere of an inert gas such as nitrogen.

The mixing weight ratio between the poly-L-lactic acid composed of L-lactic acid units and the poly-D-lactic acid composed of D-lactic acid units is preferably 80:20 to 20:80, more preferably 75:25 to 25:75, still more preferably 70:30 to 30:70, especially preferably 60:40 to 40:60. When the weight ratio of the poly-L-lactic acid composed of L-lactic acid units is within the above-described preferred range, a polylactic acid stereocomplex is likely to be formed, resulting in a sufficient increase in the melting point of the polylactic acid block copolymer finally obtained.

To efficiently promote transesterification between the segment(s) of L-lactic acid units and the segment(s) of D-lactic acid units in this mixing step, a catalyst is preferably included in the mixture. The catalyst may be the residual component(s) of the catalyst(s) used for producing the poly-L-lactic acid and/or the poly-D-lactic acid. Additionally, one or more catalysts may be further added in the mixing step.

The content of the catalyst is preferably 0.001 part by weight to 1 part by weight, especially preferably 0.001 part by weight to 0.5 part by weight with respect to 100 parts by weight of the mixture of the poly-L-lactic acid and the poly-D-lactic acid. When the amount of the catalyst is within the above-described preferred range, the frequency of transesterification of the mixture is sufficiently high, and the molecular weight of the polylactic acid block copolymer finally obtained tends to be high.

The method wherein a polyfunctional compound(s) is/are mixed with poly-L-lactic acid and poly-D-lactic acid to cause covalent bonding of the poly-L-lactic acid and the poly-D-lactic acid by the polyfunctional compound(s) to obtain a polylactic acid block copolymer (Production Method 4) is described below. The poly-L-lactic acid and the poly-D-lactic acid to be used in this production method may be produced by either the ring-opening polymerization method or the direct polymerization method described above.

One of the poly-L-lactic acid and the poly-D-lactic acid to be used to obtain the polylactic acid block copolymer in this method preferably has a weight average molecular weight of 30,000 to 100,000, and the other preferably has a weight average molecular weight of 10,000 to 30,000 in view of increasing the degree of stereocomplexation. More preferably, one of the polylactic acids has a weight average molecular weight of 35,000 to 90,000, and the other has a weight average molecular weight of 10,000 to 25,000. Especially preferably, one of the polylactic acids has a weight average molecular weight of 40,000 to 80,000, and the other has a weight average molecular weight of 10,000 to 20,000. In another preferred mode, one of the poly-L-lactic acid and the poly-D-lactic acid has a weight average molecular weight of 60,000 to 300,000, and the other has a weight average molecular weight of 30,000 to 100,000 from the viewpoint of achieving high mechanical properties of the polylactic acid resin composition after melt mixing. More preferably, one of the polylactic acids has a weight average molecular weight of 100,000 to 270,000, and the other has a weight average molecular weight of 20,000 to 80,000. Still more preferably, one of the polylactic acids has a weight average molecular weight of 125,000 to 255,000, and the other has a weight average molecular weight of 25,000 to 50,000.

The ratio between the weight average molecular weight of the poly-L-lactic acid and the weight average molecular weight of the poly-D-lactic acid used in the above-described mixing is preferably not less than 2 and less than 10 in view of increasing the degree of stereocomplexation. The ratio is more preferably not less than 3 and less than 10, especially preferably not less than 4 and less than 10.

Examples of the polyfunctional compound(s) to be used herein include polycarboxylic acid halides, polycarboxylic acids, polyisocyanates, polyamines, polyalcohols, and polyepoxy compounds. Specific examples of the polyfunctional compound(s) include polycarboxylic acid halides such as isophthalic acid chloride, terephthalic acid chloride, and 2,6-naphthalenedicarboxylic acid chloride; polycarboxylic acids such as succinic acid, adipic acid, sebacic acid, fumaric acid, terephthalic acid, isophthalic acid, and 2,6-naphthalenedicarboxylic acid; polyisocyanates such as hexamethylene diisocyanate, 4,4′-diphenylmethane diisocyanate, and toluene-2,4-diisocyanate; polyamines such as ethylenediamine, hexanediamine, and diethylene triamine; polyalcohols such as ethylene glycol, propylene glycol, butanediol, hexanediol, glycerin, trimethylolpropane, and pentaerythritol; and polyepoxy compounds such as diglycidyl terephthalate, naphthalenedicarboxylic acid diglycidyl ester, trimellitic acid triglycidyl ester, pyromellitic acid tetraglycidyl ester, ethylene glycol diglycidyl ether, propylene glycol diglycidyl ether, cyclohexanedimethanol diglycidyl ether, glycerol triglycidyl ether, trimethylolpropane triglycidyl ether, and pentaerythritol polyglycidyl ether. The polyfunctional compound(s) is/are preferably a polycarboxylic anhydride(s), polyisocyanate(s), polyalcohol(s), and/or polyepoxy compound(s), especially preferably a polycarboxylic anhydride(s), polyisocyanate(s), and/or polyepoxy compound(s). One of these or a combination of two or more of these may be used.

The amount of the polyfunctional compound(s) to be mixed is preferably 0.01 part by weight to 20 parts by weight, more preferably 0.1 part by weight to 10 parts by weight with respect to 100 parts by weight of the total of the poly-L-lactic acid and the poly-D-lactic acid. When the amount of the polyfunctional compound(s) added is within the above-described preferred range, the effect of forming covalent bonds can be sufficiently produced.

When a polyfunctional compound(s) is/are used, a reaction catalyst(s) may be added to promote the reaction of the poly-L-lactic acid and the poly-D-lactic acid with the polyfunctional compound(s). Examples of the reaction catalyst(s) include alkali metal compounds such as sodium hydroxide, potassium hydroxide, lithium hydroxide, cesium hydroxide, sodium hydrogen carbonate, potassium hydrogen carbonate, sodium carbonate, potassium carbonate, lithium carbonate, sodium acetate, potassium acetate, lithium acetate, sodium stearate, potassium stearate, lithium stearate, sodium borohydride, lithium borohydride, sodium phenylborate, sodium benzoate, potassium benzoate, lithium benzoate, disodium hydrogenphosphate, dipotassium hydrogenphosphate, dilithium hydrogenphosphate, disodium salt of bisphenol A, dipotassium salt of bisphenol A, dilithium salt of bisphenol A, sodium salt of phenol, potassium salt of phenol, lithium salt of phenol, and cesium salt of phenol; alkaline earth metal compounds such as calcium hydroxide, barium hydroxide, magnesium hydroxide, strontium hydroxide, calcium hydrogen carbonate, barium carbonate, magnesium carbonate, strontium carbonate, calcium acetate, barium acetate, magnesium acetate, strontium acetate, calcium stearate, magnesium stearate, and strontium stearate; tertiary amines such as triethylamine, tributylamine, trihexylamine, triamylamine, triethanolamine, dimethyl amino ethanol, triethylenediamine, dimethylphenylamine, dimethylbenzylamine, 2-(dimethylaminomethyl)phenol, dimethylaniline, pyridine, picoline, and 1,8-diazabicyclo[5.4.0]undecene-7; imidazole compounds such as 2-methylimidazole, 2-ethylimidazole, 2-isopropylimidazole, 2-ethyl-4-methylimidazole, and 4-phenyl-2-methylimidazole; quaternary ammonium salts such as tetramethylammonium chloride, tetraethylammonium chloride, tetrabutylammonium bromide, trimethylbenzylammonium chloride, triethylbenzylammonium chloride, tripropylbenzylammonium chloride, and N-methylpyridinium chloride; phosphine compounds such as trimethylphosphine, triethylphosphine, tributylphosphine, and trioctylphosphine; phosphonium salts such as tetramethylphosphonium bromide, tetrabutylphosphonium bromide, tetraphenylphosphonium bromide, ethyltriphenylphosphonium bromide, and triphenylbenzylphosphonium bromide; phosphoric acid esters such as trimethyl phosphate, triethyl phosphate, tributyl phosphate, trioctyl phosphate, tributoxyethyl phosphate, triphenyl phosphate, tricresyl phosphate, trixylenyl phosphate, cresyl diphenyl phosphate, octyl diphenyl phosphate, tri(p-hydroxy)phenyl phosphate, and tri(p-methoxy)phenyl phosphate; organic acids such as oxalic acid, p-toluenesulfonic acid, dinonylnaphthalene disulfonic acid, and dodecylbenzenesulfonic acid; and Lewis acids such as boron trifluoride, aluminum tetrachloride, titanium tetrachloride, and tin tetrachloride. One of these or a combination of two or more of these may be used.

The amount of the catalyst(s) to be added is preferably 0.001 part by weight to 1 part by weight with respect to 100 parts by weight of the total of the poly-L-lactic acid and the poly-D-lactic acid. When the amount of the catalyst(s) is within the above-described preferred range, a sufficient reaction-promoting effect can be obtained, and the molecular weight of the polylactic acid block copolymer finally obtained tends to be high.

The method of reacting the poly-L-lactic acid and the poly-D-lactic acid with the polyfunctional compound(s) is not restricted, and examples of the method include a method wherein melt mixing is performed at a temperature of not less than the end of melting point of the component having a higher melting point, which is selected between the poly-L-lactic acid and the poly-D-lactic acid.

Examples of the method wherein melt mixing is performed at a temperature of not less than the end of melting point include a method wherein the poly-L-lactic acid and the poly-D-lactic acid are mixed either by a batch method or by a continuous method. Examples of the extruder include single screw extruders, twin screw extruders, plastomill, kneaders, and stirred tank reactors equipped with a pressure reducing device. To enable uniform and sufficient kneading, a single screw extruder or a twin screw extruder is preferably used.

In terms of temperature conditions for the melt mixing, the melt mixing is preferably carried out at a temperature of not less than the end of melting point of the component having a higher melting point, which is selected between the poly-L-lactic acid and the poly-D-lactic acid. The temperature is preferably 140° C. to 250° C., more preferably 160° C. to 230° C., especially preferably 180° C. to 210° C. When the mixing temperature is within the above-described preferred range, the fluidity does not decrease too much, and the molecular weight of the mixture is less likely to decrease.

In terms of time conditions for the melt mixing, the period is preferably 0.1 to 30 minutes, more preferably 0.3 to 20 minutes, especially preferably 0.5 to 10 minutes. When the mixing time is within the above-described preferred range, the poly-L-lactic acid and the poly-D-lactic acid can be uniformly mixed, and thermal degradation is less likely to occur during the mixing.

The pressure conditions during the melt mixing are not restricted, and the mixing may be carried out either in the air or under an atmosphere of an inert gas such as nitrogen.

The mixing weight ratio between the poly-L-lactic acid composed of L-lactic acid units and the poly-D-lactic acid composed of D-lactic acid units is preferably 90:10 to 10:90, more preferably 80:20 to 20:80. The mixing weight ratio is especially preferably 75:25 to 60:40 or 40:60 to 25:75. When the weight ratio of the poly-L-lactic acid composed of L-lactic acid units is within the above-described preferred range, a polylactic acid stereocomplex is likely to be formed, resulting in a sufficient increase in the melting point of the polylactic acid block copolymer finally obtained.

The polylactic acid block copolymer obtained by mixing the polyfunctional compound(s) with the poly-L-lactic acid and the poly-D-lactic acid is a high molecular weight product because covalent bonding between the poly-L-lactic acid and the poly-D-lactic acid occurs due to the polyfunctional compound(s). After the mixing, solid-state polymerization can also be carried out by the above-mentioned method.

Cyclic Compound Containing Glycidyl Group and/or Acid Anhydride

The polylactic acid resin composition needs to contain a cyclic compound containing a glycidyl group or acid anhydride to allow end-capping at the carboxyl or hydroxyl terminus of the polylactic acid block copolymer to increase the heat resistance and the wet heat stability, and to produce the polylactic acid resin composition in a favorable manufacturing environment in which the irritating odor of chlorine compounds and the like is not generated.

The cyclic compound containing a glycidyl group or acid anhydride may be contained in the polylactic acid resin composition, or may be included during the preparation of the polylactic acid block copolymer. The order of addition of the cyclic compound containing a glycidyl group or acid anhydride during the preparation of the polylactic acid block copolymer is not limited and, for example, the cyclic compound may be added when the poly-L-lactic acid and the poly-D-lactic acid is mixed, or may be added after the mixing of the poly-L-lactic acid and the poly-D-lactic acid. Alternatively, the poly-L-lactic acid or the poly-D-lactic acid may preliminarily contain the cyclic compound containing a glycidyl group and/or acid anhydride. The content of the cyclic compound containing a glycidyl group and/or acid anhydride in the polylactic acid resin composition is described later.

The molecular weight of the cyclic compound containing a glycidyl group or acid anhydride is not more than 800 from the viewpoint of the reactivity with the terminus of the polylactic acid block copolymer. When the cyclic compound has a molecular weight of not more than 600, the reactivity with the terminal group of the polylactic acid block copolymer can be further increased. When the lower limit of the molecular weight is not less than 100, the degree of evaporation during the reaction is low.

Examples of the glycidyl-containing cyclic compound contained in the polylactic acid resin composition include glycidyl-modified compounds having an isocyanurate compound as the basic skeleton and 1 to 3 functional groups, represented by General Formula (2).

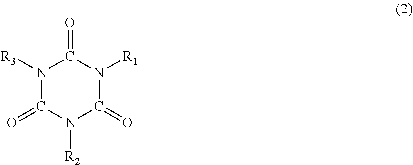

In the compounds represented by General Formula (2), R₁-R₃ may be the same or different, and at least one of R₁-R₃ represents a glycidyl group. Isocyanurate compounds having different numbers of glycidyl groups may be added to the polylactic acid block copolymer. Each functional group other than the glycidyl group(s) in R₁-R₃ is selected from hydrogen, C₁-C₁₀ alkyl, hydroxyl, and allyl. The number of carbon atoms in the alkyl group is preferably as small as possible, and diallyl monoglycidyl isocyanurate, monoallyl diglycidyl isocyanurate, and triglycidyl isocyanurate are preferably used since these have high melting points and excellent heat resistance.

The glycidyl-containing cyclic compound contained in the polylactic acid resin composition is preferably one or more compounds selected from, for example, diglycidyl phthalate, diglycidyl terephthalate, diglycidyl tetrahydrophthalate, diglycidyl hexahydrophthalate, and cyclohexanedimethanol diglycidyl ether.

The acid-anhydride-containing cyclic compound contained in the polylactic acid resin composition is preferably one or more compounds selected from, for example, phthalic anhydride, maleic anhydride, pyromellitic dianhydride, trimellitic anhydride, 1,2-eye lohexanedicarboxylic anhydride, and 1,8-naphthalenedicarboxylic anhydride.

When the cyclic compound containing a glycidyl group or acid anhydride is added, a reaction catalyst(s) may be added to promote the reaction of the polylactic acid block copolymer with the compound. Examples of the reaction catalyst(s) include alkali metal compounds such as sodium hydroxide, potassium hydroxide, lithium hydroxide, cesium hydroxide, sodium hydrogen carbonate, potassium hydrogen carbonate, sodium carbonate, potassium carbonate, lithium carbonate, sodium acetate, potassium acetate, lithium acetate, sodium stearate, potassium stearate, lithium stearate, sodium borohydride, lithium borohydride, sodium phenylborate, sodium benzoate, potassium benzoate, lithium benzoate, disodium hydrogenphosphate, dipotassium hydrogenphosphate, dilithium hydrogenphosphate, disodium salt of bisphenol A, dipotassium salt of bisphenol A, dilithium salt of bisphenol A, sodium salt of phenol, potassium salt of phenol, lithium salt of phenol, and cesium salt of phenol; alkaline earth metal compounds such as calcium hydroxide, barium hydroxide, magnesium hydroxide, strontium hydroxide, calcium hydrogen carbonate, barium carbonate, magnesium carbonate, strontium carbonate, calcium acetate, barium acetate, magnesium acetate, strontium acetate, calcium stearate, magnesium stearate, and strontium stearate; tertiary amines such as triethylamine, tributylamine, trihexylamine, triamylamine, triethanolamine, dimethyl amino ethanol, triethylenediamine, dimethylphenylamine, dimethylbenzylamine, 2-(dimethylaminomethyl)phenol, dimethylaniline, pyridine, picoline, and 1,8-diazabicyclo[5.4.0]-7-undecene; imidazole compounds such as 2-methylimidazole, 2-ethylimidazole, 2-isopropylimidazole, 2-ethyl-4-methylimidazole, and 4-phenyl-2-methylimidazole; quaternary ammonium salts such as tetramethylammonium chloride, tetraethylammonium chloride, tetrabutylammonium bromide, trimethylbenzylammonium chloride, triethylbenzylammonium chloride, tripropylbenzylammonium chloride, and N-methylpyridinium chloride; phosphine compounds such as trimethylphosphine, triethylphosphine, tributylphosphine, and trioctylphosphine; phosphonium salts such as tetramethylphosphonium bromide, tetrabutylphosphonium bromide, tetraphenylphosphonium bromide, ethyltriphenylphosphonium bromide, and triphenylbenzylphosphonium bromide; phosphoric acid esters such as trimethyl phosphate, triethyl phosphate, tributyl phosphate, trioctyl phosphate, tributoxyethyl phosphate, triphenyl phosphate, tricresyl phosphate, trixylenyl phosphate, cresyl diphenyl phosphate, octyl diphenyl phosphate, tri(p-hydroxy)phenyl phosphate, and tri(p-methoxy)phenyl phosphate; organic acids such as oxalic acid, p-toluenesulfonic acid, dinonylnaphthalene disulfonic acid, and dodecylbenzenesulfonic acid; and Lewis acids such as boron trifluoride, aluminum tetrachloride, titanium tetrachloride, and tin tetrachloride. One of these or a combination of two or more of these may be used.

The amount of the catalyst(s) to be added is preferably 0.001 part by weight to 0.5 part by weight with respect to 100 parts by weight of the polylactic acid block copolymer. When the amount of the catalyst(s) is within the above-described preferred range, an effect to reduce the polymerization time can be obtained, and the molecular weight of the polylactic acid block copolymer finally obtained can be increased.

### Polylactic Acid Resin Composition

The polylactic acid resin composition comprises: 100 parts by weight of the polylactic acid block copolymer constituted by a poly-L-lactic acid segment(s) containing as a major component L-lactic acid and a poly-D-lactic acid segment(s) containing as a major component D-lactic acid; and 0.05 to 2 parts by weight of the cyclic compound containing a glycidyl group and/or acid anhydride. The cyclic compound is contained preferably at 0.3 to 1.5 parts by weight, more preferably at 0.6 to 1.2 parts by weight. When orientation of the cyclic compound containing a glycidyl group and/or acid anhydride in the polylactic acid resin is allowed to a preferred extent, end-capping of the carboxyl terminus or hydroxyl terminus of the polylactic acid resin composition is achieved and, as a result, the moldability, mechanical properties, and heat resistance, as well as wet heat properties and dry heat properties, can be improved. Moreover, yarn breakage is less likely to occur during spinning of the polylactic acid resin composition.

The polylactic acid resin composition obtained preferably has a degree of stereocomplexation (Sc) of 80 to 100% from the viewpoint of the heat resistance. The degree of stereocomplexation is more preferably 85 to 100%, especially preferably 90 to 100%. The degree of stereocomplexation herein means the ratio of stereocomplex crystals in the total crystals of the polylactic acid. More specifically, the degree of stereocomplexation can be calculated according to Equation (8), wherein ΔHl represents the heat of fusion of crystals of poly-L-lactic acid alone and crystals of poly-D-lactic acid alone, and ΔHh represents the heat of fusion of stereocomplex crystals as measured by differential scanning calorimetry (DSC) by increasing the temperature from 30° C. to 250° C. at a heating rate of 20° C./min.

Sc=ΔHh/(ΔHl+ΔHh)×100 (8)

The carboxyl terminal concentration is preferably not more than 10 eq/ton from the viewpoint of achieving excellent hydrolysis resistance and wet heat stability. The carboxyl terminal concentration is more preferably not more than 7 eq/ton, still more preferably not more than 5 eq/ton.

The weight average molecular weight after 100 hours of moist heat treatment at 60° C. under 95% RH is preferably not less than 80% of the weight average molecular weight before the moist heat treatment. The ratio is more preferably not less than 85%, still more preferably not less than 90%. As the ratio of the weight average molecular weight retained after the moist heat treatment increases, the wet heat stability increases. For example, when a fiber composed of the polylactic acid resin composition is subjected to ironing, its mechanical properties are less likely to be deteriorated, and qualities such as the texture is maintained, which is preferred.

The crystal melting enthalpy is preferably not less than 30 J/g at not less than 190° C. during DSC measurement in which the temperature of the polylactic acid resin composition is increased to 250° C. The crystal melting enthalpy is more preferably not less than 35 J/g, still more preferably not less than 40 J/g. A higher crystal melting enthalpy results in better heat resistance of the molded article, which is preferred from the viewpoint of residence stability under heat and durability.

The weight average molecular weight of the polylactic acid resin composition is preferably 100,000 to 500,000 from the viewpoint of mechanical properties. The weight average molecular weight is more preferably 120,000 to 450,000, especially preferably 130,000 to 400,000 from the viewpoint of moldability, mechanical properties, and residence stability under heat.

The polydispersity of the polylactic acid resin composition is preferably 1.5 to 2.5 from the viewpoint of mechanical properties. The polydispersity is more preferably 1.6 to 2.3, especially preferably 1.7 to 2.0 from the viewpoint of moldability and mechanical properties. The weight average molecular weight and the polydispersity are values which are measured by gel permeation chromatography (GPC) using as a solvent hexafluoroisopropanol or chloroform, and calculated in terms of a poly(methyl methacrylate) standard.

The method of producing the polylactic acid resin composition is not limited, and the polylactic acid resin composition can be preferably produced using a heat melt mixing device such as an extruder or a kneader by any of the 3 methods described below, (I) to (III).

The production method (I) of the polylactic acid resin composition is a method in which the polylactic acid block copolymer is melt-mixed with the cyclic compound containing a glycidyl group and/or acid anhydride. The method of melt mixing may be either a batch method or a continuous method. Examples of the extruder include single screw extruders, twin screw extruders, plastomill, kneaders, and stirred tank reactors equipped with a pressure reducing device. In view of enabling uniform and sufficient kneading, a single screw extruder or a twin screw extruder is preferably used.

Melt mixing is preferably carried out at a temperature of 180° C. to 250° C. The temperature is more preferably 200° C. to 240° C., still more preferably 205° C. to 235° C. When the mixing temperature is within the preferred range, the fluidity does not decrease too much, and the molecular weight of the mixture is less likely to decrease.

The time of the melt mixing is preferably 0.1 minute to 30 minutes, more preferably 0.3 minute to 20 minutes, especially preferably 0.5 minute to 10 minutes. When the mixing time is within the preferred range, the polylactic acid block copolymer can be uniformly mixed with the cyclic compound containing a glycidyl group or acid anhydride, and thermal degradation is less likely to caused by the mixing.

The pressure conditions for the melt mixing are not limited, and the melt mixing may be carried out either in the air or under an atmosphere of an inert gas such as nitrogen.

The production method (II) of the polylactic acid resin composition is a method in which poly-L-lactic acid and poly-D-lactic acid are preliminarily mixed, and the cyclic compound containing a glycidyl group or acid anhydride is then added to the resulting mixture, followed by subjecting the obtained mixture to solid-state polymerization at a temperature lower than the melting point of the mixture. The method of the melt mixing in this method may be the mixing method applied to the above-described production method for the polylactic acid resin composition, and the extruder and the conditions of the temperature, time, and pressure during the mixing may also be the same as those described for the above-described production method for the polylactic acid resin composition.

The production method (III) of the polylactic acid resin composition is a method in which poly-L-lactic acid, poly-D-lactic acid, and the cyclic compound containing a glycidyl group or acid anhydride are mixed together at once, and the resulting mixture is then subjected to solid-state polymerization at a temperature lower than the melting point of the mixture. The method of the melt mixing in this method may be the mixing method applied to the above-described production method for the polylactic acid resin composition, and the extruder and the conditions of the temperature, time, and pressure during the mixing may also be the same as those described for the above-described production method for the polylactic acid resin composition.

The polylactic acid resin composition may be mixed with a polyfunctional compound(s) to increase the alternating property of the poly-L-lactic acid composed of L-lactic acid units (segment(s) composed of L-lactic acid units) and the poly-D-lactic acid composed of D-lactic acid units (segment(s) composed of D-lactic acid units) in the finally obtained polylactic acid resin as long as the desired effect is not deteriorated.

Examples of the polyfunctional compound(s) to be used herein include polycarboxylic acid halides, polycarboxylic acids, polyisocyanates, polyamines, polyalcohols, and polyepoxy compounds. Specific examples of the polyfunctional compound(s) include polycarboxylic acid halides such as isophthalic acid chloride, terephthalic acid chloride, and 2,6-naphthalenedicarboxylic acid chloride; polycarboxylic acids such as succinic acid, adipic acid, sebacic acid, fumaric acid, terephthalic acid, isophthalic acid, and 2,6-naphthalenedicarboxylic acid; polyisocyanates such as hexamethylene diisocyanate, 4,4′-diphenylmethane diisocyanate, and toluene-2,4-diisocyanate; polyamines such as ethylenediamine, hexanediamine, and diethylene triamine; polyalcohols such as ethylene glycol, propylene glycol, butanediol, hexanediol, glycerin, trimethylolpropane, and pentaerythritol; and polyepoxy compounds such as diglycidyl terephthalate, naphthalenedicarboxylic acid diglycidyl ester, trimellitic acid triglycidyl ester, pyromellitic acid tetraglycidyl ester, ethylene glycol diglycidyl ether, propylene glycol diglycidyl ether, cyclohexanedimethanol diglycidyl ether, glycerol triglycidyl ether, trimethylolpropane triglycidyl ether, and pentaerythritol polyglycidyl ether. The polyfunctional compound(s) is/are preferably a polycarboxylic anhydride(s), polyisocyanate(s), polyalcohol(s), and/or polyepoxy compound(s), especially preferably a polycarboxylic anhydride(s), polyisocyanate(s), and/or polyepoxy compound(s). One of these or a combination of two or more of these may be used.

The amount of the polyfunctional compound to be mixed is preferably 0.01 part by weight to 20 parts by weight, more preferably 0.1 part by weight to 10 parts by weight with respect to 100 parts by weight of the total of the poly-L-lactic acid and the poly-D-lactic acid. When the amount of the polyfunctional compound is within the above-described preferred range, the effect of using the polyfunctional compound can be exerted.

When a polyfunctional compound(s) is/are used, a reaction catalyst(s) may be added to promote the reaction of the poly-L-lactic acid and the poly-D-lactic acid with the polyfunctional compound(s). Examples of the reaction catalyst(s) include alkali metal compounds such as sodium hydroxide, potassium hydroxide, lithium hydroxide, cesium hydroxide, sodium hydrogen carbonate, potassium hydrogen carbonate, sodium carbonate, potassium carbonate, lithium carbonate, sodium acetate, potassium acetate, lithium acetate, sodium stearate, potassium stearate, lithium stearate, sodium borohydride, lithium borohydride, sodium phenylborate, sodium benzoate, potassium benzoate, lithium benzoate, disodium hydrogenphosphate, dipotassium hydrogenphosphate, dilithium hydrogenphosphate, disodium salt of bisphenol A, dipotassium salt of bisphenol A, dilithium salt of bisphenol A, sodium salt of phenol, potassium salt of phenol, lithium salt of phenol, and cesium salt of phenol; alkaline earth metal compounds such as calcium hydroxide, barium hydroxide, magnesium hydroxide, strontium hydroxide, calcium hydrogen carbonate, barium carbonate, magnesium carbonate, strontium carbonate, calcium acetate, barium acetate, magnesium acetate, strontium acetate, calcium stearate, magnesium stearate, and strontium stearate; tertiary amines such as triethylamine, tributylamine, trihexylamine, triamylamine, triethanolamine, dimethyl amino ethanol, triethylenediamine, dimethylphenylamine, dimethylbenzylamine, 2-(dimethylaminomethyl)phenol, dimethylaniline, pyridine, picoline, and 1,8-diazabicyclo[5.4.0]-7-undecene; imidazole compounds such as 2-methylimidazole, 2-ethylimidazole, 2-isopropylimidazole, 2-ethyl-4-methylimidazole, and 4-phenyl-2-methylimidazole; quaternary ammonium salts such as tetramethylammonium chloride, tetraethylammonium chloride, tetrabutylammonium bromide, trimethylbenzylammonium chloride, triethylbenzylammonium chloride, tripropylbenzylammonium chloride, and N-methylpyridinium chloride; phosphine compounds such as trimethylphosphine, triethylphosphine, tributylphosphine, and trioctylphosphine; phosphonium salts such as tetramethylphosphonium bromide, tetrabutylphosphonium bromide, tetraphenylphosphonium bromide, ethyltriphenylphosphonium bromide, and triphenylbenzylphosphonium bromide; phosphoric acid esters such as trimethyl phosphate, triethyl phosphate, tributyl phosphate, trioctyl phosphate, tributoxyethyl phosphate, triphenyl phosphate, tricresyl phosphate, trixylenyl phosphate, cresyl diphenyl phosphate, octyl diphenyl phosphate, tri(p-hydroxy)phenyl phosphate, and tri(p-methoxy)phenyl phosphate; organic acids such as oxalic acid, p-toluenesulfonic acid, dinonylnaphthalene disulfonic acid, and dodecylbenzenesulfonic acid; and Lewis acids such as boron trifluoride, aluminum tetrachloride, titanium tetrachloride, and tin tetrachloride. One of these or a combination of two or more of these may be used.

The amount of the reaction catalyst(s) is preferably 0.001 part by weight to 0.5 part by weight with respect to 100 parts by weight of the total of the poly-L-lactic acid and the poly-D-lactic acid. When the amount of the catalyst(s) is within the above-described preferred range, the effect of reducing the polymerization time can be obtained, and the molecular weight of the polylactic acid resin finally obtained can be increased.

The polylactic acid resin composition may contain a conventional additive as long as the composition is not deteriorated. Examples of the conventional additive include catalyst deactivating agents (hindered phenol compounds, thioether compounds, vitamin compounds, triazole compounds, polyvalent amine compounds, hydrazine derivative compounds, and phosphorous-based compounds). Two or more of these may be used in combination. In particular, the polylactic acid resin composition preferably contains at least one phosphorous-based compound, and the at least one phosphorous-based compound is more preferably a phosphate compound(s), phosphite compound(s), and/or inorganic metal phosphate compound(s).

Specific examples of the catalyst deactivating agents composed of a phosphorous-based compound include phosphite compounds such as “Adekastab” (registered trademark) AX-71 (dioctadecyl phosphate), PEP-8 (distearyl pentaerythritol diphosphite), and PEP-36 (cyclic neopentatetraylbis(2,6-t-butyl-4-methylphenyl)phosphite), manufactured by ADEKA Corporation; and at least one inorganic metal phosphate compound selected from sodium dihydrogen phosphate, potassium dihydrogen phosphate, lithium dihydrogen phosphate, calcium dihydrogen phosphate, disodium hydrogen phosphate, dipotassium hydrogen phosphate, calcium hydrogen phosphate, sodium hydrogen phosphite, potassium phosphite, calcium hydrogen phosphite, sodium hypophosphite, potassium hypophosphite, and calcium hypophosphite. Among these, sodium dihydrogen phosphate and potassium dihydrogen phosphate are more preferred.

Other examples of the conventional additive include plasticizers (for example, polyalkylene glycol plasticizers, polyester plasticizers, polycarboxylic acid ester plasticizers, glycerin plasticizers, phosphoric acid ester plasticizers, epoxy plasticizers, aliphatic acid amides such as stearic acid amide and ethylene-bis-stearic acid amide, pentaerythritol, sorbitols, polyacrylic acid esters, silicone oils, and paraffins; from the viewpoint of the anti-bleedout property, polyalkylene glycol plasticizers such as polyalkylene glycols including polyethylene glycol, polypropylene glycol, poly(ethylene oxide/propylene oxide) block and/or random copolymers, polytetramethylene glycol, ethylene oxide addition polymers of bisphenols, propylene oxide addition polymers of bisphenols, tetrahydrofuran addition polymers of bisphenols, and their end-capped compounds including those obtained by epoxy modification, ester modification, ether modification, and/or the like of ends of these polyalkylene glycols; polycarboxylic acid ester plasticizers such as bis(butyl diglycol)adipate, methyl diglycol butyl diglycol adipate, benzyl methyl diglycol adipate, acetyl tributyl citrate, methoxycarbonyl methyl dibutyl citrate, and ethoxycarbonyl methyl dibutyl citrate; and glycerin plasticizers such as glycerin monoacetomonolaurate, glycerin diacetomonolaurate, glycerin monoacetomonostearate, glycerin diacetomonooleate, and glycerin monoacetomonomontanate), impact resistance improvers (for example, natural rubber; polyethylenes such as low-density polyethylenes and high-density polyethylenes; polypropylenes; impact-resistant modified polystyrenes; polybutadienes; styrene/butadiene copolymers; ethylene/propylene copolymers; ethylene/methyl acrylate copolymers; ethylene/ethyl acrylate copolymers; ethylene/vinyl acetate copolymers; ethylene/glycidyl methacrylate copolymers; polyester elastomers such as polyethylene terephthalate/poly(tetramethylene oxide) glycol block copolymers and polyethylene terephthalate/isophthalate/poly(tetramethylene oxide) glycol block copolymers; butadiene core shell elastomers such as MBS; and acrylic core shell elastomers; which may be used individually or in combination of two or more thereof; wherein examples of the butadiene or acrylic core shell elastomers include “Metablen”, manufactured by Mitsubishi Rayon, “Kaneace” (registered trademark), manufactured by Kaneka, and “Paraloid” (registered trademark), manufactured by Rohm and Haas), fillers (fillers in the forms of fibers, plates, powders, particles, and the like, more specifically, fibrous/whisker-like fillers such as glass fibers, PAN-based and pitch-based carbon fibers, metal fibers including stainless steel fibers, aluminum fibers, and brass fibers, organic fibers including aromatic polyamide fibers, plaster fibers, ceramic fibers, asbestos fibers, zirconia fibers, aluminum fibers, silica fibers, titanium oxide fibers, silicon carbide fibers, rock wools, potassium titanate whiskers, barium titanate whiskers, aluminum borate whiskers, and silicon nitride whiskers; kaolin; silica; calcium carbonate; glass beads; glass flakes; glass microballoons; molybdenum disulfide; wollastonite; montmorillonite; titanium oxide; zinc oxide; calcium polyphosphate; graphite; and barium sulfate), flame retardants (for example, red phosphorus, brominated polystyrene, brominated polyphenylene ether, brominated polycarbonate, magnesium hydroxide, melamine, cyanuric acid and salts thereof, and silicon compounds), ultraviolet absorbers (for example, resorcinol, salicylate, benzotriazole, and benzophenone), heat stabilizers (hindered phenol, hydroquinone, phosphites, and substitution products thereof), lubricants, mold release agents (for example, montanic acid and salts thereof, esters thereof, half esters thereof, stearyl alcohol, stearamide, and polyethylene wax), coloring agents containing a dye (for example, nigrosine) or pigment (for example, cadmium sulfide or phthalocyanine), color-protection agents (for example, phosphites and hypophosphites), conducting agents and coloring agents (for example, carbon black), sliding property improving agents (for example, graphite and fluorine resins), and antistatic agents. One or more of these additives may be added.

The polylactic acid resin composition may contain poly-L-lactic acid and/or poly-D-lactic acid in addition to the polylactic acid block copolymer as long as the composition is not deteriorated.

The poly-L-lactic acid is a polymer containing as a major component L-lactic acid, and contains L-lactic acid units preferably at not less than 70 mol %, more preferably at not less than 90 mol %, still more preferably at not less than 95 mol %, especially preferably at not less than 98 mol %.

The poly-D-lactic acid is a polymer containing as a major component D-lactic acid, and contains D-lactic acid units preferably at not less than 70 mol %, more preferably at not less than 90 mol %, still more preferably at not less than 95 mol %, especially preferably at not less than 98 mol %.

The poly-L-lactic acid and the poly-D-lactic acid may contain other component units as long as the performance of the obtained polylactic acid resin composition is not deteriorated. Examples of the component units other than L-lactic acid units and D-lactic acid units include polycarboxylic acid, polyalcohol, hydroxycarboxylic acid, and lactone, similarly to the other component units that may be contained in the segment containing as a major component L-lactic acid and the segment containing as a major component D-lactic acid constituting the polylactic acid block copolymer.

The weight average molecular weights of the poly-L-lactic acid and the poly-D-lactic acid are not limited, and preferably not less than 100,000 from the viewpoint of mechanical properties. The weight average molecular weights are more preferably not less than 120,000, especially preferably not less than 140,000 from the viewpoint of the moldability and mechanical properties. The weight average molecular weight and the polydispersity are values which are measured by gel permeation chromatography (GPC) using as a solvent hexafluoroisopropanol or chloroform, and calculated in terms of a poly(methyl methacrylate) standard.

The order of mixing of the poly-L-lactic acid and/or the poly-D-lactic acid with the polylactic acid resin composition is not limited. The poly-L-lactic acid and/or the poly-D-lactic acid may be added to the polylactic acid resin composition, or, after mixing the poly-L-lactic acid or the poly-D-lactic acid, the polylactic acid block copolymer and the cyclic compound containing a glycidyl group or acid anhydride may be added to the resulting mixture.

The amount of the poly-L-lactic acid and/or the poly-D-lactic acid contained in the polylactic acid resin composition is preferably 10 parts by weight to 900 parts by weight, more preferably 30 parts by weight to 400 parts by weight with respect to 100 parts by weight of the polylactic acid resin composition. When the amount of the poly-L-lactic acid and/or the poly-D-lactic acid is within the preferred range, a high stereocomplex-forming performance can be achieved, which is preferred.

The polylactic acid resin composition may further contain at least one of other thermoplastic resins (polyethylene, polypropylene, polystyrene, acrylic resins, acrylonitrile/butadiene/styrene copolymers, polyamide, polycarbonate, polyphenylene sulfide resins, polyether ether ketone resins, polyester, polysulfone, polyphenylene oxide, polyacetal, polyimide, polyetherimide, cellulose esters, and the like), thermosetting resins (phenol resins, melamine resins, polyester resins, silicone resins, epoxy resins, and the like), soft thermoplastic resins (ethylene/glycidyl methacrylate copolymers, polyester elastomers, polyamide elastomers, ethylene/propylene terpolymers, ethylene/butene-1 copolymers, and the like), and the like as long as the composition is not adversely affected.

When an acrylic resin is used, preferred examples of the resin generally include acrylic resins containing as a major component alkyl (meth)acrylate units having a C₁-C₄ alkyl group(s). Further, the alkyl (meth)acrylate having a C₁-C₄ alkyl group(s) may be copolymerized with another alkyl acrylate having a C₁-C₄ alkyl group(s) and/or an aromatic vinyl compound(s) such as styrene.

Examples of the alkyl (meth)acrylate having an alkyl group include methyl acrylate, methyl methacrylate, ethyl acrylate, ethyl methacrylate, butyl acrylate, butyl methacrylate, cyclohexyl acrylate, and cyclohexyl methacrylate. When an acrylic resin is used, the acrylic resin is especially preferably a polymethyl methacrylate composed of methyl methacrylate.

During processing of the polylactic acid resin composition as a molded product into a molded article or the like, the resin composition is likely to form a polylactic acid stereocomplex having a high melting point even after the resin composition is once heat-melted and then solidified. Since molded products obtained have excellent heat resistance and hydrolysis resistance, they can be especially effectively processed into fibers/cloths, non-woven fabrics, sheets, films, and foams.

When the polylactic acid resin composition is processed into a fiber, the fiber may be used in the form of a multifilament, monofilament, staple fiber, tow, spunbond, or the like. The composition is especially preferably used as a multifilament because of its excellent spinnability during high-speed spinning, color tone, mechanical properties such as the strength, and the like.

The method of processing the polylactic acid resin composition into a fiber may be a conventionally known melt spinning method. From the viewpoint of efficiently allowing formation of stereocomplex crystals and increasing the degree of orientation of the fiber, a high-speed spinning step and a stretching step are preferably employed. By stretching of the fiber composed of the polylactic acid resin composition, the fiber can be sufficiently oriented, and mechanical properties of the fiber are therefore improved. In addition, by carrying out heat treatment at the same time, a fiber with sufficient crystallization and excellent shrinkage properties can be obtained.

The high-speed spinning of the polylactic acid resin composition is preferably carried out at a spinning speed of 500 to 10,000 m/min. since molecular orientation occurs at such a spinning speed, leading to enhancement of the processability during the later step of stretching. The spinning speed means the circumferential velocity of the first godet roll for drawing yarn. Since a higher degree of molecular orientation is required to allow draw-false twisting and the like, the spinning speed is more preferably not less than 2000 m/min., still more preferably not less than 3000 m/min. The spinning speed is especially preferably not less than 4000 m/min. On the other hand, in consideration of the processing stability during the spinning, the spinning speed is preferably not more than 7000 m/min. The unstretched yarn obtained by this high-speed spinning step has a high degree of orientation, a capacity as a precursor that allows efficient formation of stereocomplex crystals, and excellent mechanical properties. Thus, the unstretched yarn shows excellent processability in the stretching step.

The step of stretching the unstretched yarn composed of the polylactic acid resin composition obtained as described above may be a step in which preheating/stretching/heat setting are carried out with a heat roller/heat roller, or the fiber may be produced with a cold roller/hot plate/heat roller. Since polylactic acid has only weak interactions among molecular chains because of its molecular structure, the stretching is preferably carried out with a heat roller/heat roller. Since the unstretched yarn obtained by high-speed spinning as described above has a high degree of orientation, the preheating temperature in the stretching step (for example, the temperature of the first heat roller or hot plate) may be set to a temperature of 80 to 140° C., if appropriate.

By carrying out the heat setting process in the stretching step at a temperature higher than the preheating temperature, crystallization of the resulting fiber can be promoted, and dimensional stability, and heat resistance due to stereocomplex crystal formation can be given to the fiber. Thus, the heat setting temperature is more preferably not less than the preheating temperature and is 130 to 200° C.

In the draw-false twisting step of the fiber composed of the polylactic acid resin composition, a conventionally known draw-false twisting process such as the out-draw process or the in-draw process may be selected as appropriate. The in-draw process is preferred from the viewpoint of simplification of the manufacturing facility and low-cost production of the fiber. As the twisting body in the draw-false twisting process, a pin, belt, disk, or the like may be employed. A belt or disk is preferably employed since it allows high-speed draw-false twisting and therefore enhancement of the amount of production of per unit time, resulting in low-cost production of a fiber. The heater of the draw-false twisting machine may be either a contact type heater or a non-contact type heater. A non-contact type heater is preferred from the viewpoint of reducing abrasion of the fiber composed of the polylactic acid resin composition. The temperature of the heater is preferably appropriately selected at 100 to 200° C. from the viewpoint of giving mechanical strength, dimensional stability, and heat resistance to the false-twisted yarn. When the temperature is within this range, the fiber can be stably produced without yarn breakage in the draw-false twisting step, and sufficiently oriented crystallization can be achieved to give excellent mechanical strength, dimensional stability, and heat resistance. To increase the dimensional stability of the draw-false-twisted yarn, relaxation heat treatment may also be carried out after the draw-false twisting. The fiber composed of the polylactic acid resin composition obtained by the method described above not only has excellent mechanical properties and dimensional stability, but also achieves sufficient formation of stereocomplex crystals so that the fiber has excellent iron heat resistance and durability, and is applicable to high-temperature dyeing.

Examples of uses of the fiber composed of the polylactic acid resin composition include clothing requiring hydrolysis resistance, for example, sportswear such as outdoor wear, golf wear, athletic wear, ski wear, snowboard wear, and pants therefor; casual wear such as blouson; and women's/men's outerwear such as coats, winter clothes, and rainwear. Examples of preferred uses of the fiber in which excellent durability in long-term use and wet aging properties are required include uniforms; beddings such as quilts and futon mattresses, thin quilts, kotatsu futons, floor cushions, baby blankets, and blankets; side clothes and covers for pillows, cushions, and the like; mattresses and bed pads; bed sheets for hospitals, medical uses, hotels, and babies; and bed materials such as covers for sleeping bags, cradles, baby carriages, and the like. The fiber can also be preferably used for interior materials for automobiles, and may be most preferably used for carpets for automobiles and non-woven fabrics for ceiling materials, which require high hydrolysis resistance and wet aging properties. Uses of the fiber are not limited to these, and examples of other uses include weed control sheets for agricultural purposes, water-proof sheets for building materials, fishing lines, fishing nets, layer nets, non-woven fabrics for protecting vegetation, civil engineering nets, sandbags, pots for raising seedlings, agricultural materials, and draining bags.

When the molded product composed of the polylactic acid resin composition is a multifilament, its strength is preferably not less than 3.0 cN/dtex from the practical viewpoint. The strength is more preferably not less than 3.5 cN/dtex, still more preferably not less than 4.0 cN/dtex. On the other hand, from the viewpoint of industrially allowing stable production, the upper limit of the strength is preferably not more than 9.0 cN/dtex.

When the molded product composed of the polylactic acid resin composition is a multifilament, the strength retention, which is an index of hydrolysis resistance, is preferably 60 to 99%. The strength retention is more preferably 70 to 99%, still more preferably 80 to 99%, especially preferably 85 to 99%. Determining the strength retention, a multifilament composed of a polylactic acid resin composition is immersed in water placed in a closed container, and the closed container is then subjected to heat treatment at 130° C. for 40 minutes. The value of the strength retention is calculated based on the ratio between the strength before the heat treatment and the strength after the heat treatment.

When injection molding is carried out as the method of producing the molded product, in view of the heat resistance, the metal mold temperature is preferably set within the temperature range from the glass-transition temperature to the melting point of the polylactic acid resin composition, more preferably 60° C. to 240° C., still more preferably 70° C. to 220° C., still more preferably 80° C. to 200° C., and each molding cycle in the injection molding is preferably operated for not more than 150 seconds, more preferably not more than 90 seconds, still more preferably not more than 60 seconds, still more preferably not more than 50 seconds.

When blow forming is carried out as the method of producing the molded product, examples of the method include a method in which the polylactic acid resin composition is molded by injection molding according to the above method into a closed-end tubular molded matter (parison), and transferred to a metal mold of blow forming whose temperature is set within the range of the glass-transition temperature of the polylactic acid resin composition to the glass-transition temperature+80° C., preferably 60° C. to 140° C., more preferably 70° C. to 130° C., followed by stretching with a stretching rod while compressed air is supplied from an air nozzle, to obtain a molded product.

When vacuum forming is carried out as the method of producing the molded product, examples of the method include, in view of the heat resistance, a method in which the polylactic acid resin composition is heated with a heater such as a hot plate or hot air at 60° C. to 150° C., preferably 65° C. to 120° C., more preferably 70° C. to 90° C., followed by bringing the sheet into close contact with a metal mold whose temperature is 30 to 150° C., preferably 40° C. to 100° C., more preferably 50° C. to 90° C. while the pressure inside the metal mold is reduced, thereby performing molding.

When press forming is carried out as the method of producing the molded product, examples of the method include, in view of the heat resistance, a method in which the polylactic acid resin composition is heated with a heater such as a hot plate or hot air at 60° C. to 150° C., preferably 65° C. to 120° C., more preferably 70° C. to 90° C., followed by bringing the sheet into close contact with a metal mold composed of a male mold and a female mold whose temperature is 30 to 150° C., preferably 40° C. to 100° C., more preferably 50° C. to 90° C., and pressurizing the sheet, thereby performing mold clamping.

When the molded product composed of the polylactic acid resin composition is an injection-molded article, the heat resistance of the molded article can be evaluated based on the deformation in a heat sag test. For example, when the deformation is measured by retaining a square plate molded article of 80 mm×80 mm by supporting its one side at 60° C. for 30 minutes, the deformation is preferably not more than 20 mm from the viewpoint of the heat resistance. Deformation is more preferably not more than 15 mm, still more preferably not more than 10 mm, especially preferably not more than 5 mm. There is no lower limit of deformation.

When the molded article composed of the polylactic acid resin composition is an injection-molded article, the strength retention, which is an index of dry heat properties of a molded article, is preferably not less than 50%. The strength retention is more preferably not less than 55%, still more preferably not less than 60%, especially preferably not less than 65%. There is no upper limit of the strength retention.

When the molded product composed of the polylactic acid resin composition is used as a film, sheet, injection-molded article, extrusion-molded article, vacuum pressure-molded article, blow-molded article, or complex with another/other material(s), the molded product is useful for uses such as civil engineering and construction materials, stationery, medical supplies, automobile parts, electrical/electronic components, and optical films.

Specific examples of the uses include electrical/electronic components such as relay cases, coil bobbins, optical pickup chassis, motor cases, housings and internal parts for laptop computers, housings and internal parts for CRT displays, housings and internal parts for printers, housings and internal parts for mobile terminals including mobile phones, mobile computers and handheld-type mobiles, housings and internal parts for recording media (e.g., CD, DVD, PD, and FDD) drives, housings and internal parts for copiers, housings and internal parts for facsimile devices, and parabolic antennas. Other examples of the uses include parts for home and office electric appliances such as VTR parts, television parts, iron parts, hair driers, rice cooker parts, microwave oven parts, acoustic parts, parts for video equipments including video cameras and projectors, substrates for optical recording media including “Laser disc (registered trademark)”, compact discs (CDs), CD-ROM, CD-R, CD-RW, DVD-ROM, DVD-R, DVD-RW, DVD-RAM, and Blu-ray disks, illumination parts, refrigerator parts, air conditioner parts, typewriter parts, and word processor parts. The molded product is also useful for, for example, housings and internal parts for electronic musical instruments, home game machines, and portable game machines; electrical/electronic components such as gears, cases, sensors, LEP lamps, connectors, sockets, resistors, relay cases, switches, coil bobbins, condensers, cases for variable condensers, optical pickups, oscillators, terminal blocks, transformers, plugs, printed circuit boards, tuners, speakers, microphones, headphones, small motors, magnetic head bases, power modules, semiconductors, liquid crystals, FDD carriages, FDD chassis, motor brush holders, transformer members, and coil bobbins; building components such as sash rollers, blind curtain parts, pipe joints, curtain liners, blind parts, gas meter parts, water meter parts, water heater parts, roof panels, adiabatic walls, adjusters, plastic floor posts, ceiling hangers, stairs, doors, and floors; fishery-related members such as bait bags; civil engineering-related members such as weed control bags, weed control nets, curing sheets, slope protection sheets, fly ash-preventing sheet, drain sheets, water retention sheets, sludge/slime dewatering bags, and concrete molds; underhood parts for automobiles such as air flow meters, air pumps, thermostat housings, engine mounts, ignition bobbins, ignition cases, clutch bobbins, sensor housings, idle speed control bulbs, vacuum switching bulbs, ECU (Electric Control Unit) housings, vacuum pump cases, inhibitor switches, rotation sensors, acceleration sensors, distributor caps, coil bases, ABS actuator cases, the top and the bottom of radiator tanks, cooling fans, fan shrouds, engine covers, cylinder head covers, oil caps, oil pans, oil filters, fuel caps, fuel strainers, distributor caps, vapor canister housings, air cleaner housings, timing belt covers, brake booster parts, cases, tubes, tanks, hoses, clips, valves, and pipes; interior parts for automobiles such as torque control levers, safety belt parts, register blades, washer levers, window regulator handles, knobs for window regulator handles, passing light levers, sun visor brackets, and motor housings; exterior parts for automobiles such as roof rails, fenders, garnishes, bumpers, door mirror stays, spoilers, hood louvers, wheel covers, wheel caps, grill apron cover frames, lamp reflectors, lamp bezels, and door handles; automobile connectors such as wire harness connectors, SMJ connectors (connectors for trunk connection), PCB connectors (board connectors), and door grommet connectors; machine parts such as gears, screws, springs, bearings, levers, key stems, cams, ratchets, rollers, water-supply parts, toy parts, fans, fishing guts, pipes, washing jigs, motor parts, microscopes, binoculars, cameras, and watches; agricultural members such as multi-films, tunnel films, bird-preventing sheets, pots for raising seedlings, vegetation piles, seeding strings/tapes, sheets for sprouting, inner sheets for greenhouses, stoppers for agricultural vinyl sheets, slow-releasing fertilizers, root barriers, print laminates, fertilizer bags, sample bags, and sandbags; fillers (fibers) and molding materials used for shale gas/oil extraction; sanitary supplies; medical supplies such as medical films; packaging films for calendars, stationery, clothing and food; vessels and tableware such as trays, blisters, knives, forks, spoons, tubes, plastic cans, pouches, containers, tanks and baskets; containers and wrappings such as hot-fill containers, containers for microwave oven cooking, transparent heat-resistant containers for food, containers for cosmetics, wrapping films, foam buffers, paper laminates, shampoo bottles, beverage bottles, cups, candy wrappings, shrink labels, lid materials, windowed envelopes, baskets for fruits, tearable tapes, easy-peel wrappings, egg packs, HDD wrappings, compost bags, recording media wrappings, shopping bags, and wrapping films for electric and electronic parts; various types of clothing; interior goods; carrier tapes; print laminates; thermal stencil printing films; mold releasing films; porous films; container bags; credit cards; cash cards; ID cards; IC cards; optical elements; electroconductive embossed tapes; IC trays; golf tees; garbage bags; shopping bags; tooth brushes; stationery; plastic folders; bags; chairs; tables; cooler boxes; rakes; hose reels; planters; hose nozzles; surfaces of dining tables and desks; furniture panels; kitchen cabinets; pen caps; and gas lighters.

### EXAMPLES

Our compositions, molded products and methods are described below by way of Examples. However, this disclosure is not limited by these Examples. The number of parts in the Examples represents parts by weight. The methods of measuring physical properties and the like were as follows.

### (1) Molecular Weight

The weight average molecular weight and the polydispersity of the polylactic acid resin composition are values measured by gel permeation chromatography (GPC) and calculated in terms of a poly(methyl methacrylate) standard. The GPC measurement was carried out using a detector WATERS 410, which is a differential refractometer manufactured by Nihon Waters K.K., a pump MODEL 510, manufactured by Nihon Waters K.K., and columns “Shodex” (registered trademark) GPC HFIP-806M and “Shodex” (registered trademark) GPC HFIP-LG, manufactured by Showa Denko K. K., which are linearly connected. In terms of conditions for the measurement, the flow rate was 0.5 mL/min. In the measurement, hexafluoroisopropanol was used as a solvent, and 0.1 mL of a solution with a sample concentration of 1 mg/mL was injected.

### (2) Thermal Properties

The melting point and the amount of heat due to melting of the polylactic acid resin composition were measured with a differential scanning calorimeter (DSC) manufactured by PerkinElmer Japan Co., Ltd. In terms of measurement conditions, the measurement was carried out with 5 mg of a sample under a nitrogen atmosphere at a heating rate of 20° C./min.

The melting point herein means the temperature at the peak top of the peak due to melting of crystals, and the end of melting point means the temperature at the end of the peak due to melting of crystals. In the obtained results, a melting point of not less than 190° C. and less than 250° C. was judged to be due to formation of a polylactic acid stereocomplex, and a melting point of not less than 150° C. and less than 190° C. was judged to be due to nonoccurrence of formation of a polylactic acid stereocomplex. The melting point of the polylactic acid resin composition herein means the melting point measured by increasing the temperature at a heating rate of 20° C./min. from 30° C. to 250° C. in the second temperature increase. The amount of heat due to melting of stereocomplex crystals (ΔHmsc) is a value obtained by calculating the peak area of the peak due to melting of stereocomplex crystals measured by the method described above.

As a thermal property of the polylactic acid resin composition, the parameter value according to Formula (9) was calculated.

(Tm−Tms)/(Tme−Tm) (9)

The parameters in Formula (9) are as follows: Tm, the melting point derived from stereocomplex crystals of the polylactic acid resin composition (peak top temperature in the peak due to melting of crystals); Tms, the start of melting point of stereocomplex crystals of the polylactic acid resin composition; Tme, the end of melting point of the polylactic acid resin composition. Each value was obtained by subjecting 5 mg of a sample to measurement using a differential scanning calorimeter (DSC) manufactured by PerkinElmer Japan Co., Ltd. under a nitrogen atmosphere. The measured value was obtained by increasing the temperature at a heating rate of 40° C./min. from 30° C. to 250° C. during the first temperature increase and then decreasing the temperature at a cooling rate of 40° C./min. to 30° C., further followed by increasing the temperature at a heating rate of 40° C./min. from 30° C. to 250° C. during the second temperature increase.

### (3) Degree of Stereocomplexation (Sc)

The degree of stereocomplexation (Sc) of the polylactic acid resin composition was calculated according to Equation (4).

Sc=ΔHh/(ΔHl−ΔHh)×100 (4)

In this equation, ΔHl represents the heat of fusion of crystals of poly-L-lactic acid alone and crystals of poly-D-lactic acid alone, which appears at a temperature of not less than 150° C. and less than 190° C., and ΔHh represents the heat of fusion of stereocomplex crystals, which appears at a temperature of not less than 190° C. and less than 250° C.

The degree of stereocomplexation (Sc) of the polylactic acid resin composition in the present Examples was calculated from the peak due to melting of crystals measured during the second temperature increase in the differential scanning calorimetry (DSC).

### (4) Carboxyl Terminal Concentration

The carboxyl terminal concentration of the polylactic acid resin composition was calculated by dissolving a pellet of the polylactic acid resin composition in an o-cresol/chloroform mixed solution, and then carrying out titration with 0.02 N ethanolic potassium hydroxide solution.

### (5) Molecular Weight Retention

To determine the molecular weight retention of the polylactic acid resin composition, a pellet of the polylactic acid resin composition was subjected to moist heat treatment at 60° C. under 95% RH for 100 hours, and calculation was then carried out according to Equation (10) based on the weight average molecular weight before the moist heat treatment (Mw1) and the weight average molecular weight after the moist heat treatment (Mw2).

Molecular weight retention (%)=Mw2/Mw1×100 (10)

### (6) Strength of Stretched Yarn

The strength of a stretched yarn composed of the polylactic acid resin composition was measured using TENSILON UCT-100, manufactured by Orientec Co., Ltd., according to JIS L 1013 (chemical fiber filament yarn test method, 1998) under constant-speed stretching conditions (length of the sample between grips, 20 cm; stretching rate, 20 cm/minute).

### (7) Strength Retention of Stretched Yarn

The strength of the stretched yarn composed of the polylactic acid resin composition was measured by the following procedure. One gram of the stretched yarn composed of the polylactic acid resin composition was wound on a bobbin such that contraction of the yarn did not occur. The resulting sample was then placed in a sealable container together with 300 ml of water, and heated at a heating rate of 4° C./minute such that the water temperature in the container was 130° C. The sample was then kept at a constant temperature of 130° C. for 40 minutes, and then cooled at a cooling rate of 4° C./minute. When the water temperature in the container decreased to 50° C. or less, the sample was removed and washed with water, followed by calculating the strength retention according to Equation (11) based on the tensile strength before the heat treatment (T1) and the tensile strength after the heat treatment (T2).

Strength retention (%)=T2/T1×100 (11)

### (8) Iron Heat Resistance of Fabric

To each fabric composed of the polylactic acid resin composition obtained in the Examples below, a household iron at a medium temperature (surface temperature, 170° C.) was applied for 10 minutes. The iron heat resistance was rated on a 4-point scale as follows: “good”, no change could be found; “fair”, slight hardening was found; “bad”, apparent hardening was found; and “worse”, remarkable hardening, or melting occurred. Each sample was regarded as acceptable when the iron heat resistance was rated as “good” or “fair”.

### (9) Heat Resistance of Molded Article: Heat Sag Test

Deformation of a square plate molded article of 80 mm×80 mm composed of the polylactic acid resin composition was measured by retaining the plate by supporting its one side at 60° C. for 30 minutes. The smaller the deformation, the better the heat resistance.

### (10) Strength Retention of Molded Article

An ASTM #1 dumbbell molded article composed of the polylactic acid resin composition was subjected to measurement of the tensile strength before heat treatment (T1) and the tensile strength after heat treatment (T2) at 150° C. for 100 hours, and the dry heat strength retention of the molded article was calculated according to Equation (12).

Strength retention (%)=T2/T1×100 (12)

The poly-L-lactic acid and the poly-D-lactic acid used in the Examples (Examples 1 to 20 and Comparative Examples 1 to 16) were as follows.

PLA1: Poly-L-lactic acid obtained in Reference Example 1 (Mw=50,000; polydispersity, 1.5)

PLA2: Poly-L-lactic acid obtained in Reference Example 2 (Mw=140,000; polydispersity, 1.6)

PLA3: Poly-L-lactic acid obtained in Reference Example 3 (Mw=200,000; polydispersity, 1.7)

PDA1: Poly-D-lactic acid obtained in Reference Example 4 (Mw=40,000; polydispersity, 1.5)

PDA2: Poly-D-lactic acid obtained in Reference Example 5 (Mw=70,000; polydispersity, 1.5)

PDA3: Poly-D-lactic acid obtained in Reference Example 6 (Mw=130,000; polydispersity, 1.6)

PDA4: Poly-D-lactic acid obtained in Reference Example 7 (Mw=180,000; polydispersity, 1.6)

### Reference Example 1

In a reactor equipped with an agitator and a reflux condenser, 50 parts of 90% aqueous L-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-L-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 5 hours, thereby obtaining a poly-L-lactic acid (PLA1). PLA1 had a weight average molecular weight of 50,000, polydispersity of 1.5, and melting point of 157° C.

### Reference Example 2

In a reactor equipped with an agitator and a reflux condenser, 50 parts of 90% aqueous L-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-L-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 12 hours, thereby obtaining a poly-L-lactic acid (PLA2). PLA2 had a weight average molecular weight of 140,000, polydispersity of 1.6, and melting point of 165° C.

### Reference Example 3

In a reactor equipped with an agitator and a reflux condenser, 50 parts of 90% aqueous L-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-L-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 18 hours, thereby obtaining a poly-L-lactic acid (PLA3). PLA3 had a weight average molecular weight of 200,000, polydispersity of 1.7, and melting point of 170° C.

### Reference Example 4

In a reactor equipped with an agitator and a reflux condenser, 50 parts of 90% aqueous D-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-D-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 5 hours, thereby obtaining a poly-D-lactic acid (PDA1). PDA1 had a weight average molecular weight of 40,000, polydispersity of 1.5, and melting point of 156° C.

### Reference Example 5

In a reactor equipped with an agitator and a reflux condenser, 50 parts of 90% aqueous L-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-D-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 9 hours, thereby obtaining a poly-D-lactic acid (PDA2). PDA2 had a weight average molecular weight of 70,000, polydispersity of 1.5, and melting point of 161° C.

### Reference Example 6

In a reactor equipped with an agitator and a reflux condenser, 50 parts of 90% aqueous D-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-D-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 12 hours, thereby obtaining a poly-D-lactic acid (PDA3). PDA3 had a weight average molecular weight of 130,000, polydispersity of 1.6, and melting point of 164° C.

### Reference Example 7

In a reactor equipped with an agitator and a reflux condenser, 50 parts of 90% aqueous D-lactic acid solution was placed, and the temperature was adjusted to 150° C. Thereafter, the reaction was allowed to proceed for 3.5 hours while the pressure was gradually reduced to allow evaporation of water. Subsequently, under nitrogen atmosphere at normal pressure, 0.02 part of stannous acetate was added to the resulting reaction product, and the polymerization reaction was allowed to proceed at 170° C. for 7 hours while the pressure was gradually reduced to 13 Pa. The resulting poly-D-lactic acid was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 18 hours, thereby obtaining a poly-D-lactic acid (PDA4). PDA4 had a weight average molecular weight of 180,000, polydispersity of 1.6, and melting point of 168° C.

### (A) Polylactic Acid Resin

A-1: Polylactic acid stereocomplex obtained in Reference Example 8 (mixture of poly-L-lactic acid and poly-D-lactic acid) (Mw=110,000; polydispersity, 2.7)

A-2: Polylactic acid block copolymer obtained in Reference Example 9 (Mw=130,000; polydispersity, 2.4)

A-3: Polylactic acid stereocomplex obtained in Reference Example 10 (mixture of poly-L-lactic acid and poly-D-lactic acid) (Mw=130,000; polydispersity, 2.6)

A-4: Polylactic acid block copolymer obtained in Reference Example 11 (Mw=160,000; polydispersity, 2.3)

A-5: Polylactic acid stereocomplex obtained in Reference Example 12 (mixture of poly-L-lactic acid and poly-D-lactic acid) (Mw=40,000; polydispersity, 1.8)

A-6: Polylactic acid block copolymer obtained in Reference Example 13 (Mw=60,000; polydispersity, 1.6)

A-7: Polylactic acid stereocomplex obtained in Reference Example 14 (mixture of poly-L-lactic acid and poly-D-lactic acid) (Mw=100,000; polydispersity, 2.2)

A-8: Polylactic acid block copolymer obtained in Reference Example 15 (Mw=130,000; polydispersity, 2.0)

A-9: Polylactic acid stereocomplex obtained in Reference Example 16 (mixture of poly-L-lactic acid and poly-D-lactic acid) (Mw=120,000; polydispersity, 2.4)

A-10: Polylactic acid block copolymer obtained in Reference Example 17 (Mw=140,000; polydispersity, 2.2)

A-11: Polylactic acid stereocomplex obtained in Reference Example 18 (mixture of poly-L-lactic acid and poly-D-lactic acid) (Mw=130,000; polydispersity, 2.5)

A-12: Polylactic acid block copolymer obtained in Reference Example 19 (Mw=150,000; polydispersity, 2.3)

A-13: Polylactic acid stereocomplex obtained in Reference Example 20 (mixture of poly-L-lactic acid and poly-D-lactic acid) (Mw=150,000; polydispersity, 2.6)

A-14: Polylactic acid block copolymer obtained in Reference Example 21 (Mw=170,000; polydispersity, 2.4)

A-15: Polylactic acid stereocomplex obtained in Reference Example 22 (mixture of poly-L-lactic acid and poly-D-lactic acid) (Mw=170,000; polydispersity, 2.4)

A-16: Polylactic acid block copolymer obtained in Reference Example 23 (Mw=190,000; polydispersity, 2.2)

A-17: Polylactic acid block copolymer obtained in Reference Example 24 (Mw=150,000; polydispersity, 1.8)

A-18: Polylactic acid block copolymer obtained in Reference Example 25 (Mw=110,000; polydispersity, 1.7)

A-19: Polylactic acid stereocomplex obtained in Reference Example 26 (mixture of poly-L-lactic acid and poly-D-lactic acid) (Mw=170,000; polydispersity, 1.7)

PLA3: Poly-L-lactic acid obtained in Reference Example 3 (Mw=200,000; polydispersity, 1.7)

### Reference Example 8

PLA3, obtained in Reference Example 3, and PDA1, obtained in Reference Example 4, were preliminarily subjected to crystallization treatment before mixing, under nitrogen atmosphere at a temperature of 110° C. for 2 hours. Subsequently, 50 parts by weight of crystallized PLA3 was added from the resin hopper of a twin screw extruder, and 50 parts by weight of PDA1 was added from the side resin hopper provided at the later-mentioned position of L/D=30 to perform melt mixing. The twin screw extruder had a plasticization portion at a temperature of 190° C. in the area from the resin hopper to the position of L/D=10, and a kneading disc at the position of L/D=30 as a screw capable of giving shearing so that the structure allows mixing under shearing. Using the twin screw extruder, melt mixing of PLAT and PDA1 was carried out under reduced pressure at a kneading temperature of 210° C. to obtain a polylactic acid stereocomplex (A-1). The polylactic acid stereocomplex (A-1) had a weight average molecular weight of 110,000, polydispersity of 2.7, melting point of 211° C., and degree of stereocomplexation of 100%.

### Reference Example 9

The polylactic acid stereocomplex (A-1) obtained in Reference Example 8 was subjected to crystallization treatment under nitrogen atmosphere at 110° C. for 1 hour, and then to solid-state polymerization under a pressure of 60 Pa at 140° C. for 3 hours, at 150° C. for 3 hours, and then at 160° C. for 18 hours, thereby obtaining a polylactic acid block copolymer (A-2) having not less than 3 segments. The polylactic acid block copolymer (A-2) had a weight average molecular weight of 130,000, polydispersity of 2.4, melting point of 211° C., and degree of stereocomplexation of 100%.

### Reference Example 10

Melt mixing was carried out in the same manner as in Reference Example 8 except that 70 parts by weight of PLA3 and 30 parts by weight of PDA1 were fed to the twin screw extruder, to obtain a polylactic acid stereocomplex (A-3). The polylactic acid stereocomplex (A-3) had a weight average molecular weight of 130,000, polydispersity of 2.6, melting points of 214° C. and 151° C. as double peaks, and degree of stereocomplexation of 95%.

### Reference Example 11

Solid-state polymerization of the polylactic acid stereocomplex (A-3) obtained in Reference Example 10 was carried out in the same manner as in Reference Example 9, to obtain a polylactic acid block copolymer (A-4) having not less than 3 segments. The polylactic acid block copolymer (A-4) had a weight average molecular weight of 160,000, polydispersity of 2.3, melting points of 215° C. and 171° C. as double peaks, and degree of stereocomplexation of 97%.

### Reference Example 12

Melt mixing was carried out in the same manner as in Reference Example 10 except that the melt mixing with the twin screw extruder was carried out using PLAT as the poly-L-lactic acid and PDA1 as the poly-D-lactic acid, to obtain a polylactic acid stereocomplex (A-5). The polylactic acid stereocomplex (A-5) had a weight average molecular weight of 40,000, polydispersity of 1.8, melting point of 215° C., and degree of stereocomplexation of 100%.

### Reference Example 13

Solid-state polymerization of the polylactic acid stereocomplex (A-5) obtained in Reference Example 12 was carried out in the same manner as in Reference Example 9, to obtain a polylactic acid block copolymer (A-6). The polylactic acid block copolymer (A-6) had a weight average molecular weight of 60,000, polydispersity of 1.6, melting point of 215° C., and degree of stereocomplexation of 100%.

### Reference Example 14

Melt mixing was carried out in the same manner as in Reference Example 10 except that the melt mixing with the twin screw extruder was carried out using PLA2 as the poly-L-lactic acid and PDA1 as the poly-D-lactic acid, to obtain a polylactic acid stereocomplex (A-7). The polylactic acid stereocomplex (A-7) had a weight average molecular weight of 100,000, polydispersity of 2.2, melting points of 213° C. and 152° C. as double peaks, and degree of stereocomplexation of 96%.

### Reference Example 15

Solid-state polymerization of the polylactic acid stereocomplex (A-7) obtained in Reference Example 14 was carried out in the same manner as in Reference Example 9, to obtain a polylactic acid block copolymer (A-8). The polylactic acid block copolymer (A-8) had a weight average molecular weight of 120,000, polydispersity of 2.0, melting points of 212° C. and 170° C. as double peaks, and degree of stereocomplexation of 98%.

### Reference Example 16

Melt mixing was carried out in the same manner as in Reference Example 10 except that the melt mixing with the twin screw extruder was carried out using PLA2 as the poly-L-lactic acid and PDA2 as the poly-D-lactic acid, to obtain a polylactic acid stereocomplex (A-9). The polylactic acid stereocomplex (A-9) had a weight average molecular weight of 120,000, polydispersity of 2.4, melting points of 212° C. and 160° C. as double peaks, and degree of stereocomplexation of 93%.

### Reference Example 17

Solid-state polymerization of the polylactic acid stereocomplex (A-9) obtained in Reference Example 16 was carried out in the same manner as in Reference Example 9, to obtain a polylactic acid block copolymer (A-10). The polylactic acid block copolymer (A-10) had a weight average molecular weight of 140,000, polydispersity of 2.2, melting points of 212° C. and 171° C. as double peaks, and degree of stereocomplexation of 95%.

### Reference Example 18

Melt mixing was carried out in the same manner as in Reference Example 10 except that the melt mixing with the twin screw extruder was carried out using PLA2 as the poly-L-lactic acid and PDA3 as the poly-D-lactic acid, to obtain a polylactic acid stereocomplex (A-11). The polylactic acid stereocomplex (A-11) had a weight average molecular weight of 130,000, polydispersity of 2.5, melting points of 210° C. and 165° C. as double peaks, and degree of stereocomplexation of 55%.

### Reference Example 19

Solid-state polymerization of the polylactic acid stereocomplex (A-11) obtained in Reference Example 18 was carried out in the same manner as in Reference Example 9, to obtain a polylactic acid block copolymer (A-12). The polylactic acid block copolymer (A-12) had a weight average molecular weight of 150,000, polydispersity of 2.3, melting points of 211° C. and 170° C. as double peaks, and degree of stereocomplexation of 63%.

### Reference Example 20

Melt mixing was carried out in the same manner as in Reference Example 10 except that the melt mixing with the twin screw extruder was carried out using PLA3 as the poly-L-lactic acid and PDA2 as the poly-D-lactic acid, to obtain a polylactic acid stereocomplex (A-13). The polylactic acid stereocomplex (A-13) had a weight average molecular weight of 150,000, polydispersity of 2.6, melting points of 211° C. and 161° C. as double peaks, and degree of stereocomplexation of 90%.

### Reference Example 21

Solid-state polymerization of the polylactic acid stereocomplex (A-13) obtained in Reference Example 20 was carried out in the same manner as in Reference Example 9, to obtain a polylactic acid block copolymer (A-14). The polylactic acid block copolymer (A-14) had a weight average molecular weight of 170,000, polydispersity of 2.4, melting points of 212° C. and 171° C. as double peaks, and degree of stereocomplexation of 95%.

### Reference Example 22

Melt mixing was carried out in the same manner as in Reference Example 10 except that the melt mixing with the twin screw extruder was carried out using PLA3 as the poly-L-lactic acid and PDA3 as the poly-D-lactic acid, to obtain a polylactic acid stereocomplex (A-15). The polylactic acid stereocomplex (A-15) had a weight average molecular weight of 170,000, polydispersity of 2.4, melting points of 212° C. and 168° C. as double peaks, and degree of stereocomplexation of 60%.

### Reference Example 23

Solid-state polymerization of the polylactic acid stereocomplex (A-15) obtained in Reference Example 20 was carried out in the same manner as in Reference Example 9, to obtain a polylactic acid block copolymer (A-16). The polylactic acid block copolymer (A-16) had a weight average molecular weight of 190,000, polydispersity of 2.2, melting points of 212° C. and 171° C. as double peaks, and degree of stereocomplexation of 67%.

### Reference Example 24

In a reactor equipped with an agitator, 100 parts of L-lactide and 0.15 part of ethylene glycol were uniformly melt at 160° C. under nitrogen atmosphere, and 0.01 part of stannous octoate was added to the resulting mixture, followed by allowing the ring-opening polymerization reaction to proceed for 2 hours. After completion of the polymerization reaction, the reaction product was dissolved in chloroform, and reprecipitation was allowed in methanol (5 times the volume of the solution in chloroform) with stirring to remove unreacted monomers, thereby obtaining a poly-L-lactic acid (PLA4). PLA4 had a weight average molecular weight of 80,000, polydispersity of 1.6, and melting point of 168° C.

Subsequently, 100 parts of the obtained PLA4 was melt in a reactor equipped with an agitator under nitrogen atmosphere at 200° C., and 120 parts of D-lactide was fed thereto, followed by adding 0.01 part of stannous octoate to the resulting mixture. The polymerization reaction was allowed to proceed for 3 hours. The obtained reaction product was dissolved in chloroform, and reprecipitation was allowed in methanol (5 times the volume of the solution in chloroform) with stirring to remove unreacted monomers, thereby obtaining a polylactic acid block copolymer (A-17) having 3 segments in which segments composed of D-lactic acid units are bound to PLA4 composed of L-lactic acid units. A-17 had a molecular weight of 150,000, polydispersity of 1.8, melting points of 208° C. and 169° C. as double peaks, and degree of stereocomplexation of 95%. The ratio between the weight average molecular weights of the segment composed of L-lactic acid units and the segments composed of D-lactic acid units constituting the polylactic acid block copolymer A-17 was 2.7.

### Reference Example 25

PLA3 obtained in Reference Example 3 (50 parts by weight) and PDA4 obtained in Reference Example 7 (50 parts by weight) were kneaded using a batch-type twin screw extruder (Labo Plastomill) manufactured by Toyo Seiki Co., Ltd. at a kneading temperature of 270° C. and a kneading rotation speed of 120 rpm for a kneading time of 10 minutes, to obtain a polylactic acid block copolymer (A-18) having not less than 3 segments by transesterification between a segment(s) composed of L-lactic acid units of PLA3 and a segment(s) composed of D-lactic acid units of PDA4. A-18 had a molecular weight of 110,000, polydispersity of 1.7, melting point of 211° C., and degree of stereocomplexation of 100%.

### Reference Example 26

PLA3 obtained in Reference Example 3 and PDA4 obtained in Reference Example 7 were melt-mixed in the same manner as in Reference Example 8, to obtain a polylactic acid stereocomplex (A-19). The polylactic acid stereocomplex (A-19) had a weight average molecular weight of 170,000, polydispersity of 1.7, melting points of 220° C. and 169° C. as double peaks, and degree of stereocomplexation of 55%.

(B) Cyclic Compound Containing Glycidyl Group and/or Acid Anhydride

B-1: Triglycidyl isocyanurate (“TEPIC-S” (registered trademark), manufactured by Nissan Chemical Industries, Ltd.; epoxy equivalent, 100 g/mol; molecular weight, 297)

B-2: Monoallyl diglycidyl isocyanurate (“MA-DGIC” (trade name), manufactured by Shikoku Chemicals Corporation; molecular weight, 281)

B-3: Diallyl monoglycidyl isocyanurate (“DA-MGIC” (trade name), manufactured by Shikoku Chemicals Corporation; molecular weight, 253)

B-4: Diglycidyl tetrahydrophthalate (manufactured by Tianjin Synthetic Material Research Institute; molecular weight, 284)

B-5: 1,2,4,5-Benzenetetracarboxylic acid dianhydride (trimellitic anhydride) (manufactured by Wako Pure Chemical Industries, Ltd.; molecular weight, 218)

### (C) Polyfunctional Compound

C-1: N,N′-di-2,6-diisopropylphenylcarbodiimide (“Stabaxol” (registered trademark), manufactured by Rhein Chemie Japan Ltd.; molecular weight, 363)

C-2: Hexamethylene diisocyanate (manufactured by Nippon Polyurethane Industry Co., Ltd.; molecular weight, 168)

C-3: 2,2′-(1,3-phenylene)bis(2-oxazoline) (manufactured by Mikuni Pharmaceutical Industrial Co., Ltd.; molecular weight, 216)

### (D) Nuclear Agent

D-1: Talc (“MICRO ACE” (registered trademark) P-6, manufactured by Nippon Talc Co., Ltd.)

D-2: Phosphoric acid ester sodium salt (“Adekastab” (registered trademark) NA-11, manufactured by ADEKA Corporation)

D-3: Phosphoric acid ester aluminum salt (“Adekastab” (registered trademark) NA-21, manufactured by ADEKA Corporation)

### Examples 1 to 21

At the various ratios shown in Table 1 and Table 2, a polylactic acid resin(A), a cyclic compound containing a glycidyl group or acid anhydride (B), and a nuclear agent (D) were preliminarily dry-blended, and subjected to melt mixing using a twin screw extruder having a vent. As described above, the twin screw extruder had a plasticization portion whose temperature is set to 225° C. in the area from the resin hopper to the position of L/D=10, and a kneading disc at the position of L/D=30 as a screw capable of giving shearing so that the structure allows mixing under shearing. Using the twin screw extruder, melt mixing was carried out under reduced pressure at a kneading temperature of 220° C. to obtain a pelletized polylactic acid resin composition.

Subsequently, to obtain a sample for fiber evaluation, the pellets of the polylactic acid resin composition were dried in a vacuum drier at 140° C. for 24 hours, and then fed to a melt spinning machine. The machine was operated under the following conditions: melting temperature, 220° C.; spinning temperature, 230° C.; die diameter, 0.3 mm; and spinning speed, 5000 m/minute. As a result, an unstretched yarn of type 100 dtex—24 filaments was obtained. The resulting unstretched yarn was stretched at a preheating temperature of 100° C. and a heat setting temperature of 130° C. to achieve a stretching ratio of 1.4, thereby obtaining a stretched yarn of type 70 dtex—24 filaments. Using the resulting stretched yarn, a fabric composed of 40 warps/cm and 40 wefts/cm was prepared.

On the other hand, to obtain samples for a heat resistance test and measurement of the tensile strength retention of a molded article, the pellets of the polylactic acid resin composition obtained by the melt mixing were subjected to injection molding using an injection molding apparatus (SG75H-MIV, manufactured by Sumitomo Heavy Industries, Ltd.) at a cylinder temperature of 230° C. and a metal mold temperature of 110° C., thereby preparing a square plate molded article with a thickness of 1 mm as the sample for the heat resistance test, and an ASTM #1 dumbbell molded article with a thickness of 3 mm as the sample for the measurement of the tensile strength retention.

The polylactic acid resin compositions obtained by the melt mixing, properties of the fibers, and physical properties of the injection-molded articles were as shown in Table 1 and Table 2.

TABLE 1

| | | Example 1 | Example 2 | Example 3 | Example 4 | Example 5 |
|---|---|---|---|---|---|---|
| Polylactic acid resin (A) | Type | A-2 | A-2 | A-2 | A-2 | A-4 |
| | content | 100 | 100 | 100 | 100 | 100 |
| | (parts by weight) | | | | | |
| Cyclic compound having | Type | B-1 | B-1 | B-1 | B-1 | B-1 |
| glycidyl group or acid | content | 0.1 | 0.5 | 1.0 | 1.5 | 0.1 |
| anhydride (B) | (parts by weight) | | | | | |
| Multi-functional | Type | — | — | — | — | — |
| compound (C) | content | — | — | — | — | — |
| | (parts by weight) | | | | | |
| Crystal nucleating | Type | — | — | — | — | — |
| agent (D) | content | — | — | — | — | — |
| | (parts by weight) | | | | | |
| Weight average | | 14 × 10⁴ | 15 × 10⁴ | 16 × 10⁴ | 18 × 10⁴ | 16 × 10⁴ |
| molecular weight | | | | | | |
| Dispersity | | 2.4 | 2.1 | 1.8 | 1.6 | 2.1 |
| Melting point | ° C. | 211 | 212 | 210 | 210 | 213/170 |
| (Tm-Tms)/(Tme-Tm) | | 1.5 | 1.4 | 1.4 | 1.3 | 1.4 |
| ΔHmsc | J/g | 52 | 50 | 48 | 45 | 40 |
| Sc | % | 100 | 100 | 100 | 100 | 95 |
| Caboxyl terminal | eq/ton | 17 | 9 | 5 | 2 | 15 |
| concentration | | | | | | |
| Molecular weight retention | % | 80 | 85 | 90 | 92 | 82 |
| Strength of stretched yarn | cN/dtex | 3.3 | 3.6 | 4.2 | 4.1 | 3.8 |
| Strength retention | % | 81 | 82 | 85 | 85 | 82 |
| of stretched yarn | | | | | | |
| Iron heat resistance of fabric | | good | good | good | good | good |
| Heat resistance of molded | mm | 10 | 8 | 5 | 4 | 10 |
| article (deformation amount) | | | | | | |
| Dry heat strength retention | % | 59 | 63 | 69 | 71 | 62 |
| of molded article | | | | | | |
| | | Example 6 | Example 7 | Example 8 | Example 9 | Example 10 |
| Polylactic acid resin (A) | Type | A-4 | A-4 | A-4 | A-6 | A-8 |
| | content | 100 | 100 | 100 | 100 | 100 |
| | (parts by weight) | | | | | |
| Cyclic compound having | Type | B-1 | B-1 | B-1 | B-1 | B-1 |
| glycidyl group or acid | content | 0.5 | 1.0 | 1.5 | 1.0 | 1.0 |
| anhydride (B) | (parts by weight) | | | | | |
| Multi-functional | Type | — | — | — | — | — |
| compound (C) | content | — | — | — | — | — |
| | (parts by weight) | | | | | |
| Crystal nucleating | Type | — | — | — | — | — |
| agent (D) | content | — | — | — | — | — |
| | (parts by weight) | | | | | |
| Weight average | | 17 × 10⁴ | 19 × 10⁴ | 20 × 10⁴ | 7 × 10⁴ | 15 × 10⁴ |
| molecular weight | | | | | | |
| Dispersity | | 1.9 | 1.8 | 1.6 | 1.5 | 1.7 |
| Melting point | ° C. | 215/171 | 212/171 | 210/170 | 211 | 211/170 |
| (Tm-Tms)/(Tme-Tm) | | 1.3 | 1.3 | 1.2 | 1.4 | 1.5 |
| ΔHmsc | J/g | 38 | 35 | 32 | 48 | 40 |
| Sc | % | 97 | 95 | 92 | 100 | 98 |
| Caboxyl terminal | eq/ton | 5 | 1 | 1 | 7 | 3 |
| concentration | | | | | | |
| Molecular weight retention | % | 88 | 92 | 93 | 86 | 92 |
| Strength of stretched yarn | cN/dtex | 4.0 | 4.5 | 4.2 | 2.9 | 3.6 |
| Strength retention | % | 83 | 90 | 85 | 82 | 90 |
| of stretched yarn | | | | | | |
| Iron heat resistance of fabric | | good | good | good | good | good |
| Heat resistance of molded | mm | 8 | 6 | 5 | 5 | 5 |
| article (deformation amount) | | | | | | |
| Dry heat strength retention | % | 68 | 72 | 75 | 58 | 65 |
| of molded article | | | | | | |

TABLE 2

| | | Example 11 | Example 12 | Example 13 | Example 14 | Example 15 | Example 16 |
|---|---|---|---|---|---|---|---|
| Polylactic acid resin (A) | Type | A-10 | A-14 | A-4 | A-4 | A-4 | A-4 |
| | content | 100 | 100 | 100 | 100 | 100 | 100 |
| | (parts by weight) | | | | | | |
| Cyclic compound having | Type | B-1 | B-1 | B-2 | B-3 | B-4 | B-5 |
| glycidyl group or acid | content | 1.0 | 1.0 | 1.0 | 1.0 | 1.0 | 0.5 |
| anhydride (B) | (parts by weight) | | | | | | |
| Multi-functional | Type | — | — | — | — | — | — |
| compound (C) | content | — | — | — | — | — | — |
| | (parts by weight) | | | | | | |
| Crystal nucleating | Type | — | — | — | — | — | — |
| agent (D) | content | — | — | — | — | — | — |
| | (parts by weight) | | | | | | |
| Weight average | | 17 × 10⁴ | 19 × 10⁴ | 18 × 10⁴ | 17 × 10⁴ | 18 × 10⁴ | 16 × 10⁴ |
| molecular weight | | | | | | | |
| Dispersity | | 1.9 | 2.1 | 1.9 | 2.0 | 1.8 | 1.9 |
| Melting point | ° C. | 210/170 | 209/169 | 210/171 | 208/170 | 209/171 | 208/171 |
| (Tm-Tms)/(Tme-Tm) | | 1.6 | 1.4 | 1.6 | 1.5 | 1.5 | 1.7 |
| ΔHmsc | J/g | 37 | 33 | 36 | 38 | 35 | 40 |
| Sc | % | 95 | 94 | 96 | 95 | 98 | 97 |
| Caboxyl terminal | eq/ton | 1 | 1 | 6 | 10 | 5 | 15 |
| concentration | | | | | | | |
| Molecular weight retention | % | 93 | 95 | 90 | 85 | 87 | 89 |
| Strength of stretched yarn | cN/dtex | 4.0 | 4.6 | 4.3 | 4.1 | 4.2 | 3.8 |
| Strength retention | % | 91 | 93 | 86 | 82 | 85 | 80 |
| of stretched yarn | | | | | | | |
| Iron heat resistance of fabric | | good | good | good | good | good | good |
| Heat resistance of molded | mm | 6 | 7 | 7 | 8 | 6 | 9 |
| article (deformation amount) | | | | | | | |
| Dry heat strength retention | % | 68 | 67 | 65 | 69 | 68 | 78 |
| of molded article | | | | | | | |

| | | Example 17 | Example 18 | Example 19 | Example 20 | Example 21 |
|---|---|---|---|---|---|---|
| Polylactic acid resin (A) | Type | A-17 | A-18 | A-4 | A-4 | A-4 |
| | content | 100 | 100 | 100 | 100 | 100 |
| | (parts by weight) | | | | | |
| Cyclic compound having | Type | B-1 | B-1 | B-1 | B-1 | B-1 |
| glycidyl group or acid | content | 1.0 | 1.0 | 1.0 | 1.0 | 1.0 |
| anhydride (B) | (parts by weight) | | | | | |
| Multi-functional | Type | — | — | — | — | — |
| compound (C) | content | — | — | — | — | — |
| | (parts by weight) | | | | | |
| Crystal nucleating | Type | — | — | D-1 | D-2 | D-3 |
| agent (D) | content | — | — | 0.3 | 0.3 | 0.3 |
| | (parts by weight) | | | | | |
| Weight average | | 17 × 10⁴ | 13 × 10⁴ | 18 × 10⁴ | 19 × 10⁴ | 15 × 10⁴ |
| molecular weight | | | | | | |
| Dispersity | | 1.8 | 1.6 | 1.8 | 1.8 | 1.7 |
| Melting point | ° C. | 208/169 | 211 | 215/170 | 214/172 | 215 |
| (Tm-Tms)/(Tme-Tm) | | 1.3 | 1.2 | 1.4 | 1.3 | 1.3 |
| ΔHmsc | J/g | 29 | 42 | 36 | 40 | 41 |
| Sc | % | 95 | 100 | 92 | 95 | 100 |
| Caboxyl terminal | eq/ton | 3 | 10 | 7 | 9 | 14 |
| concentration | | | | | | |
| Molecular weight retention | % | 91 | 82 | 88 | 83 | 81 |
| Strength of stretched yarn | cN/dtex | 4.2 | 3.2 | 4.3 | 4.3 | 3.9 |
| Strength retention | % | 84 | 80 | 83 | 82 | 78 |
| of stretched yarn | | | | | | |
| Iron heat resistance of fabric | | good | good | good | good | good |
| Heat resistance of molded | mm | 7 | 9 | 5 | 4 | 8 |
| article (deformation amount) | | | | | | |
| Dry heat strength retention | % | 70 | 62 | 73 | 68 | 58 |
| of molded article | | | | | | |

As the polylactic acid resin, the polylactic acid block copolymer (A-2) was used in Examples 1 to 4, and the polylactic acid block copolymer A-4 was used in Examples 5 to 8. Melt mixing of each polylactic acid resin was carried out with various amounts of triglycidyl isocyanurate (B-1), to obtain polylactic acid resin compositions. As a result, in both of the polylactic acid resins (A-2) and (A-4), the weight average molecular weight of the polylactic acid resin composition tended to increase, and the polydispersity tended to decrease, as the amount of triglycidyl isocyanurate (B-1) increased. Moreover, as the amount of the isocyanurate compound added increased, the carboxyl terminal concentration of the polylactic acid resin composition tended to decrease, and the molecular weight retention rate after the moist heat treatment tended to increase, indicating better wet heat stability. All the stretched yarns composed of the polylactic acid resin compositions had a stretched-yarn strength of not less than 3.0 cN/dtex, a stretched-yarn strength retention of not less than 80%, and excellent iron heat resistance of the fabric. Thus, the stretched yarns composed of the polylactic acid resin compositions were found to have excellent mechanical properties, heat resistance, and hydrolysis resistance. In the heat sag test of the injection-molded articles, the deformation was as small as not more than 10 mm, and the strength retention was not less than 59%, indicating both excellent heat resistance and excellent dry heat properties.

In Examples 9 to 12, (A-6, 8, 10, or 14) described in Table 1 was used as the polylactic acid resin (A), and 1 part by weight of triglycidyl isocyanurate (B-1) was added to each polylactic acid resin, to obtain polylactic acid resin compositions. In terms of physical properties of these polylactic acid resin compositions, the reaction with the isocyanurate compound increased the weight average molecular weight, and decreased the carboxyl terminal concentration to 10 eq/ton, similarly to Examples 1 to 8. The molecular weight retention rate as the polylactic acid resin composition was not less than 86%, indicating excellent wet heat stability. Except for the case of Example 9, in which the weight average molecular weight was 70,000, all stretched yarns composed of the polylactic acid resin compositions had a stretched-yarn strength of not less than 3.0 cN/dtex, a stretched-yarn strength retention of not less than 90%, and excellent iron heat resistance of the fabric. Thus, the stretched yarns composed of our polylactic acid resin compositions were found to have excellent mechanical properties, heat resistance, and hydrolysis resistance. Since the results of the heat sag test of the injection-molded articles were good similarly to Examples 1 to 8, they were found to be excellent in both heat resistance and dry heat properties.

In Examples 13 to 16, an isocyanurate compound (B-2 or B-3), diglycidyl tetrahydrophthalate (B-4), or 1,2,4,5-benzenetetracarboxylic acid dianhydride (trimellitic anhydride) (B-5), which is a cyclic compound of an acid anhydride, was used instead of triglycidyl isocyanurate (B-1), to prepare polylactic acid resin compositions. Similarly to Examples 1 to 12, all polylactic acid resin compositions tended to show an increase in the molecular weight and a decrease in the polydispersity. In terms of thermal properties, the degree of stereocomplexation was not less than 90%, and the melting enthalpy of stereocomplex crystals (ΔHmsc) was not less than 30 J/g, indicating excellent heat resistance. In terms of physical properties of the stretched yarns, the compositions showed, similarly to Examples 1 to 12, excellent mechanical properties, hydrolysis resistance, and heat resistance. In the heat sag test of the injection-molded articles, the deformation was not more than 10 mm, and the strength retention was not less than 65%, indicating excellent heat resistance as well as dry heat properties.

In Examples 17 and 18, (A-5) or (A-6) was used as the polylactic acid resin (A), to prepare polylactic acid resin compositions. Similarly to Examples 1 to 16, both polylactic acid resin compositions tended to show an increase in the molecular weight and a decrease in the polydispersity. Since the thermal properties obtained by the DSC measurement, the carboxyl terminal concentration, and the molecular weight retention rate were similar to those in Examples 1 to 16, these compositions were found to have excellent heat resistance and wet heat stability. In terms of physical properties of the stretched yarns, both compositions had a stretched-yarn strength of not less than 4.0 cN/dtex and a strength retention of not less than 80%. Thus, the compositions were found to have excellent heat resistance and hydrolysis resistance. The fabrics composed of the stretched yarns also showed good iron heat resistance. The results of the heat sag test and the results on the strength retention of the injection-molded articles were also similar to those in Examples 1 to 16, indicating excellent heat resistance and dry heat properties.

In Examples 19 to 21, triglycidyl isocyanurate (B-1) and the nuclear agent (D−1), (D-2), or (D-3), respectively, were added to the polylactic acid resin A-4, to prepare polylactic acid resin compositions. In any of the polylactic acid resin compositions, the molecular weight tended to increase, and the polydispersity tended to decrease due to the reaction with the isocyanurate compound. In terms of thermal properties, the degree of stereocomplexation (Sc) was as high as not less than 95%, and the melting enthalpy of stereocomplex crystals (AHmsc) was not less than 36 J/g, indicating excellent heat resistance. Both compositions had a stretched-yarn strength of not less than 3.9 cN/dtex and a strength retention of not less than 78%. Thus, the compositions were found to have excellent heat resistance and hydrolysis resistance. The fabrics composed of the stretched yarns showed good iron heat resistance, and the injection-molded articles showed good heat resistance and dry heat properties.

### Comparative Examples 1 to 22

At the ratios shown in Table 3 and Table 4, the polylactic acid resin (A), cyclic compound containing a glycidyl group or acid anhydride (B), polyfunctional compound (C), and nuclear agent (D) were dry-blended in advance, and melt mixing was carried out in the same manner as in the Examples, to obtain polylactic acid resin compositions. The polylactic acid resin compositions were subjected to melt spinning in the same manner as in the Examples to prepare stretched yarns and fabrics, and molded articles were prepared by injection molding for carrying out evaluations. The polylactic acid resin compositions obtained by the melt mixing, properties of the fibers, and physical properties of the injection-molded articles were as shown in Table 3 and Table 4.

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Polylactic acid resin (A) | Type | A-2 | A-2 | A-4 | A-4 | A-1 | A-3 |
| | content | 100 | 100 | 100 | 100 | 100 | 100 |
| | (parts by weight) | | | | | | |
| Cyclic compound having | Type | B-1 | B-1 | B-1 | B-1 | B-1 | B-1 |
| glycidyl group or acid | content | T | 2.5 | 0.03 | 2.5 | 1.0 | 1.0 |
| anhydride (B) | (parts by weight) | | | | | | |
| Multi-functional | Type | — | — | — | — | — | — |
| compound (C) | content | — | — | — | — | — | — |
| | (parts by weight) | | | | | | |
| Crystal nucleating | Type | — | — | — | — | — | — |
| agent (D) | content | — | — | — | — | — | — |
| | (parts by weight) | | | | | | |
| Weight average | | 13 × 10⁴ | 18 × 10⁴ | 15 × 10⁴ | 20 × 10⁴ | 11 × 10⁴ | 14 × 10⁴ |
| molecular weight | | | | | | | |
| Dispersity | | 2.4 | 1.6 | 2.1 | 1.6 | 2.6 | 1.6 |
| Melting point | ° C. | 211 | 209 | 212/170 | 213/171 | 213 | 214/151 |
| (Tm-Tms)/(Tme-Tm) | | 1.7 | 1.3 | 1.5 | 1.3 | 2.0 | 2.1 |
| ΔHmsc | J/g | 53 | 40 | 40 | 28 | 29 | 25 |
| Sc | % | 100 | 100 | 94 | 93 | 100 | 95 |
| Caboxyl terminal | eq/ton | 36 | 1 | 33 | 1 | 18 | 13 |
| concentration | | | | | | | |
| Molecular weight retention | % | 40 | 93 | 45 | 89 | 57 | 72 |
| (wet heat) | | | | | | | |
| Strength of stretched yarn | cN/dtex | 3.3 | 2.6 | 3.7 | 2.8 | 2.9 | 3.6 |
| Strength retention | % | 43 | 89 | 49 | 91 | 74 | 79 |
| of stretched yarn | | | | | | | |
| Iron heat resistance of fabric | | good | good | good | fair | fair | fair |
| Heat resistance of molded | mm | 5 | 5 | 8 | 7 | 16 | 13 |
| article (deformation amount) | | | | | | | |
| Dry heat strength retention | % | 40 | 70 | 43 | 68 | 45 | 44 |
| of molded article | | | | | | | |

| | | Comparative | Comparative | Comparative | Comparative | Comparative |
|---|---|---|---|---|---|---|
| | | Example 7 | Example 8 | Example 9 | Example 10 | Example 11 |
| Polylactic acid resin (A) | Type | A-5 | A-7 | A-9 | A-11 | A-12 |
| | content | 100 | 100 | 100 | 100 | 100 |
| | (parts by weight) | | | | | |
| Cyclic compound having | Type | B-1 | B-1 | B-1 | B-1 | B-1 |
| glycidyl group or acid | content | 1.0 | 1.0 | 1.0 | 1.0 | 1.0 |
| anhydride (B) | (parts by weight) | | | | | |
| Multi-functional | Type | — | — | — | — | — |
| compound (C) | content | — | — | — | — | — |
| | (parts by weight) | | | | | |
| Crystal nucleating | Type | — | — | — | — | — |
| agent (D) | content | — | — | — | — | — |
| | (parts by weight) | | | | | |
| Weight average | | 5 × 10⁴ | 11 × 10⁴ | 14 × 10⁴ | 15 × 10⁴ | 17 × 10⁴ |
| molecular weight | | | | | | |
| Dispersity | | 1.7 | 2.1 | 2.2 | 2.3 | 2.0 |
| Melting point | ° C. | 213 | 212/151 | 212/159 | 211/164 | 210/170 |
| (Tm-Tms)/(Tme-Tm) | | 1.5 | 1.6 | 1.7 | 2.0 | 1.9 |
| ΔHmsc | J/g | 39 | 31 | 29 | 18 | 22 |
| Sc | % | 100 | 95 | 93 | 54 | 63 |
| Caboxyl terminal | eq/ton | 10 | 7 | 1 | 1 | 1 |
| concentration | | | | | | |
| Molecular weight retention | % | 78 | 83 | 85 | 88 | 92 |
| (wet heat) | | | | | | |
| Strength of stretched yarn | cN/dtex | 2.3 | 2.6 | 2.7 | 3.5 | 3.8 |
| Strength retention | % | 70 | 75 | 80 | 82 | 85 |
| of stretched yarn | | | | | | |
| Iron heat resistance of fabric | | fair | fair | fair | worse | bad |
| Heat resistance of molded | mm | 18 | 15 | 12 | ≧20 | ≧20 |
| article (deformation amount) | | | | | | |
| Dry heat strength retention | % | 35 | 40 | 46 | 5 | 20 |
| of molded article | | | | | | |

TABLE 4

| | | Comparative | Comparative | Comparative | Comparative | Comparative | Comparative |
|---|---|---|---|---|---|---|---|
| | | Example 12 | Example 13 | Example 14 | Example 15 | Example 16 | Example 17 |
| Polylactic acid resin (A) | Type | A-13 | A-15 | A-16 | A-19 | PLA3 | A-4 |
| | content | 100 | 100 | 100 | 100 | 100 | 100 |
| | (parts by weight) | | | | | | |
| Cyclic compound having | Type | B-1 | B-1 | B-1 | B-1 | B-1 | — |
| glycidyl group or acid | content | 1.0 | 1.0 | 1.0 | 1.0 | 1.0 | — |
| anhydride (B) | (parts by weight) | | | | | | |
| Multi-functional | Type | — | — | — | — | — | C-1 |
| compound (C) | content | — | — | — | — | — | 1.0 |
| | (parts by weight) | | | | | | |
| Crystal nucleating | Type | — | — | — | — | — | — |
| agent (D) | content | — | — | — | — | — | — |
| | (parts by weight) | | | | | | |
| Weight average | | 17 × 10⁴ | 19 × 10⁴ | 21 × 10⁴ | 20 × 10⁴ | 23 × 10⁴ | 17 × 10⁴ |
| molecular weight | | | | | | | |
| Dispersity | | 2.2 | 2.2 | 1.9 | 1.7 | 1.7 | 2.6 |
| Melting point | ° C. | 211/160 | 212/167 | 210/170 | 220/169 | 172 | 214/169 |
| (Tm-Tms)/(Tme-Tm) | | 1.5 | 2.2 | 2.0 | 1.9 | 2.1 | 1.3 |
| ΔHmsc | J/g | 32 | 20 | 25 | 22 | 0 | 29 |
| Sc | % | 87 | 60 | 68 | 50 | 0 | 91 |
| Caboxyl terminal | eq/ton | 1 | 1 | 1 | 2 | 2 | 24 |
| concentration | | | | | | | |
| Molecular weight retention | % | 86 | 90 | 89 | 90 | 93 | 52 |
| (wet heat) | | | | | | | |
| Strength of stretched yarn | cN/dtex | 2.9 | 3.1 | 3.6 | 3.8 | 4.5 | 4.1 |
| Strength retention | % | 79 | 75 | 80 | 89 | 94 | 49 |
| of stretched yarn | | | | | | | |
| Iron heat resistance of fabric | | fair | worse | bad | worse | worse | bad |
| Heat resistance of molded | mm | 12 | ≧20 | ≧20 | ≧20 | ≧20 | ≧20 |
| article (deformation amount) | | | | | | | |
| Dry heat strength retention | % | 46 | 8 | 15 | 0 | 0 | 42 |
| of molded article | | | | | | | |

| | | Comparative | Comparative | Comparative | Comparative | Comparative |
|---|---|---|---|---|---|---|
| | | Example 18 | Example 19 | Example 20 | Example 21 | Example 22 |
| Polylactic acid resin (A) | Type | A-4 | A-4 | A-19 | A-19 | A-19 |
| | content | 100 | 100 | 100 | 100 | 100 |
| | (parts by weight) | | | | | |
| Cyclic compound having | Type | — | — | B-1 | B-1 | B-1 |
| glycidyl group or acid | content | — | — | 1.0 | 1.0 | 1.0 |
| anhydride (B) | (parts by weight) | | | | | |
| Multi-functional | Type | C-2 | C-3 | — | — | — |
| compound (C) | content | 1.0 | 1.0 | — | — | — |
| | (parts by weight) | | | | | |
| Crystal nucleating | Type | — | — | D-1 | D-2 | D-3 |
| agent (D) | content | — | — | 0.3 | 0.3 | 0.3 |
| | (parts by weight) | | | | | |
| Weight average | | 18 × 10⁴ | 18 × 10⁴ | 19 × 10⁴ | 18 × 10⁴ | 13 × 10⁴ |
| molecular weight | | | | | | |
| Dispersity | | 2.8 | 2.6 | 1.7 | 1.8 | 1.6 |
| Melting point | ° C. | 205/168 | 207/168 | 219/171 | 220/171 | 221/170 |
| (Tm-Tms)/(Tme-Tm) | | 1.5 | 1.4 | 1.9 | 2.1 | 1.9 |
| ΔHmsc | J/g | 20 | 23 | 23 | 21 | 26 |
| Sc | % | 82 | 85 | 54 | 56 | 65 |
| Caboxyl terminal | eq/ton | 26 | 27 | 9 | 8 | 17 |
| concentration | | | | | | |
| Molecular weight retention | % | 50 | 48 | 83 | 84 | 60 |
| (wet heat) | | | | | | |
| Strength of stretched yarn | cN/dtex | 3.2 | 3.5 | 4.3 | 4.3 | 3.6 |
| Strength retention | % | 43 | 40 | 83 | 85 | 75 |
| of stretched yarn | | | | | | |
| Iron heat resistance of fabric | | bad | bad | worse | worse | worse |
| Heat resistance of molded | mm | ≧20 | ≧20 | ≧20 | ≧20 | ≧20 |
| article (deformation amount) | | | | | | |
| Dry heat strength retention | % | 35 | 32 | 0 | 0 | 0 |
| of molded article | | | | | | |

In Comparative Examples 1 to 4, 0.03 part by weight or 2.5 parts by weight of triglycidyl isocyanurate (B-1) was added to 100 parts by weight of the polylactic acid resin (A-2) or (A-4). As a result, in Comparative Examples 1 and 3, the carboxyl terminal concentration was as high as not less than 30 eq/ton, and the molecular weight retention rate was lower than in Examples 1 to 15 even after the reaction with the isocyanurate compound. Moreover, the strength retentions of the stretched yarns obtained from the polylactic acid resin compositions of Comparative Examples 1 and 3 were less than 50%, indicating lower hydrolysis resistance. On the other hand, in Comparative Examples 2 and 4, the carboxyl terminal concentration was as low as 1 eq/ton, and the molecular weight retention rate was not less than 89% after the reaction with triglycidyl isocyanurate (B-1), indicating excellent hydrolysis resistance. However, smoking assumed to be due to the isocyanurate compound occurred during the spinning, and thinning during the cooling process of the spun yarn was unstable. This caused yarn breakage, and the strength of the stretched yarns was low.

In Comparative Examples 5 and 6, the polylactic acid stereocomplexes (A-1, 3) were used to prepare polylactic acid resin compositions by melt mixing with the isocyanurate compound. Compared to Examples 3 and 7, in which a polylactic acid block copolymer was used as the polylactic acid resin, the polylactic acid resin compositions obtained in these Comparative Examples showed higher carboxyl terminal concentrations of not less than 10 eq/ton, and lower wet heat molecular weight retention rates as the polylactic acid resin compositions, indicating lower heat resistance.

In Comparative Examples 7 to 15, the polylactic acid stereocomplexes and polylactic acid block copolymers described in Table 3 and Table 4 were used to prepare polylactic acid resin compositions by melt mixing with the isocyanurate compound. As shown in the tables, Comparative Examples 7 to 9 showed degrees of stereocomplexation of as high as not less than 90%, and carboxyl terminal concentrations of as low as not more than 10 eq/ton as polylactic acid resin compositions, indicating excellent wet heat stability. However, the weight average molecular weights of the polylactic acid resin compositions were as low as 140,000 so that the stretched-yarn strengths were lower than those in the Examples.

In Comparative Examples 10, 11, and 13 to 15, the ratio between the poly-L-lactic acid and the poly-D-lactic acid constituting the polylactic acid resin was less than 2, and the degrees of stereocomplexation of the polylactic acid resin compositions were as low as less than 70%. All polylactic acid resin compositions showed a carboxyl terminal concentration of 1 eq/ton, indicating excellent wet heat stability of the polylactic acid resin compositions, but the iron heat resistance of the fabrics and the heat resistance of the molded articles were lower than those in the Examples due to the low degrees of stereocomplexation of the polylactic acid resin compositions. On the other hand, in Comparative Example 12, the heat resistance and the wet heat molecular weight retention rate of the polylactic acid resin composition were excellent similarly to the Examples, but the stretched-yarn strength was lower than that in Example 12, in which a polylactic acid block copolymer was used as the polylactic acid resin (A).

In Comparative Example 16, PLA3, which is a homopolylactic acid, was used as the polylactic acid resin, to prepare a polylactic acid resin composition. The use of the homopolylactic acid as the polylactic acid resulted in stereocomplex formation at 0 J/g, and lower heat resistance and crystallization properties than those in the Examples. Since heating of the fabric using an iron caused melting of the fabric, the iron heat resistance was low. Deformation of the injection-molded article in the heat sag test was not less than 20 mm, and the tensile strength retention was also low. Thus, the composition was found to have low physical properties in terms of heat resistance and dry heat properties.

In Comparative Examples 17 to 19, the polyfunctional compound (C-1), (C-2), or (C-3) was added to the polylactic acid block copolymer (A-4) to prepare polylactic acid resin compositions. As a result, in any of these cases, the weight average molecular weight increased due to the reaction with the isocyanurate compound, but a decrease in the polydispersity, which can be seen with the isocyanurate compound, was not found, and the polydispersity rather showed a tendency to increase. Since the carboxyl terminal concentration was not less than 20 eq/ton, and the molecular weight retention rate was not more than 60%, their wet heat stability was lower than that in the Examples. In terms of physical properties of the stretched yarns, the strength retention was low, and the hydrolysis resistance was lower than that in the Examples. The fabrics obtained from the stretched yarns showed hardening due to heating with an iron. Deformation of the injection-molded articles in the heat sag test was not less than 20 mm, and the strength retention was less than 50%. Thus, we found that, even when a polylactic acid block copolymer is contained as the polylactic acid resin composition, use of a polyfunctional compound other than a cyclic compound containing a glycidyl group or acid anhydride results in a low heat resistance and low dry heat properties.

In Comparative Examples 20 to 22, the polylactic acid stereocomplex (A-19) was used as the polylactic acid resin (A), and triglycidyl isocyanurate (B-1) and the nuclear agent (D-1), (D-2), or (D-3) were added to prepare polylactic acid resin compositions. As a result, the degrees of stereocomplexation (Sc) of these polylactic acid resin compositions were as low as less than 70%, and the compositions had lower heat resistance than that in the Examples. The stretched yarns partially showed hardening after heating of the fabric with an iron. In terms of heat resistance of the molded articles, deformation in the heat sag test was not less than 20 mm, and the strength retention was 0%. Thus, the heat resistance and the dry heat properties were found to be lower than those in the Examples.

### Examples 22 and 23

PLA3, which was obtained in Reference Example 3, and PDA1, which was obtained in Reference Example 4, were subjected to crystallization treatment under nitrogen atmosphere at a temperature of 110° C. for 2 hours prior to mixing. Subsequently, the crystallized PLA3 and triglycidyl isocyanurate (B-1) in the amounts shown in Table 5 were fed to a twin screw extruder from the resin hopper while the crystallized PDA1 was fed from the later-mentioned side resin hopper provided at the position of L/D=30, to carry out melt mixing. The twin screw extruder had a plasticization portion at a temperature of 190° C. in the area from the resin hopper to the position of L/D=10, and a kneading disc at the position of L/D=30 as a screw capable of giving shearing so that the structure allows mixing under shearing.

The kneaded mixtures were subjected to crystallization treatment under nitrogen atmosphere at 110° C. for 1 hour, and then to solid-state polymerization under a pressure of 60 Pa at 150° C. for 24 hours, thereby obtaining polylactic acid resin compositions. The obtained polylactic acid resin compositions were subjected to melt spinning in the same manner as in the Examples to prepare stretched yarns and fabrics, and molded articles were prepared by injection molding to carry out evaluations.

The polylactic acid resin compositions, properties of the fibers, and physical properties of the injection-molded articles were as shown in Table 5.

### Example 24

The polylactic acid stereocomplex (A-3), which was obtained in Reference Example 10, and triglycidyl isocyanurate (B-1) were fed to a twin screw extruder from the resin hopper, to carry out melt mixing. The element constitution and the temperature setting of the extruder were as described in Examples 22 and 23. Subsequently, the kneaded mixture after the melt mixing was subjected to solid-state polymerization by the method described in Examples 22 and 23. By the same methods as described in Examples 1 to 21, stretched yarns and fabrics were prepared, and molded articles for evaluations were prepared by injection molding.

The polylactic acid resin composition, properties of the fiber, and physical properties of the injection-molded articles were as shown in Table 5.

### Examples 25 to 27

PLA3, which was obtained in Reference Example 3, PDA4, which was obtained in Reference Example 7, and (A-4), which was obtained in Reference Example 11, were preliminarily subjected, before mixing, to crystallization treatment under nitrogen atmosphere at 110° C. for 2 hours.

To prepare polylactic acid resin compositions, the polylactic acid block copolymer (A-4) and triglycidyl isocyanurate (B-1) in the amounts shown in Table 3 were preliminarily fed to a twin screw extruder from the resin hopper to carry out melt mixing, thereby obtaining a mixture. Subsequently, the mixture, and PLA3 and PDA4 in the amounts shown in Table 5 were fed to the twin screw extruder from the resin hopper to carry out melt mixing, thereby preparing polylactic acid resin compositions. In Examples 25 to 27, solid-state polymerization was not carried out after the kneading of the polylactic acid resin compositions. The polylactic acid resin compositions were also subjected to melt spinning in the same manner as in Examples 1 to 21 to prepare stretched yarns and fabrics, and molded articles were prepared by injection molding for carrying out evaluations.

The obtained polylactic acid resin compositions, properties of the fibers, and physical properties of the injection-molded articles were as shown in Table 5.

### Comparative Examples 23 and 24

Kneaded mixtures were prepared using a twin screw extruder by the same method as in Examples 22 and 23, to prepare polylactic acid resin compositions. In Comparative Examples 23 and 24, solid-state polymerization of the kneaded mixtures was not carried out. The obtained polylactic acid resin compositions were subjected to melt spinning in the same manner as in the Examples to prepare stretched yarns and fabrics. Injection-molded articles were also prepared in the same manner as in the Examples, to obtain samples for evaluations. Physical properties of the polylactic acid resin compositions and the injection-molded articles were as shown in Table 5.

TABLE 5

| | | | | | Example | Example | Example | Comparative | Comparative |
|---|---|---|---|---|---|---|---|---|---|
| | | Example 22 | Example 23 | Example 24 | 25 | 26 | 27 | Example 23 | Example 24 |
| Polylactic acid resin (A) | Type | PLA3 | PLA3 | — | PLA3 | PLA3 | PLA3 | PLA3 | PLA3 |
| | content | 50 | 70 | — | 40 | 30 | 50 | 50 | 70 |
| | (parts | | | | | | | | |
| | by weight) | | | | | | | | |
| | Type | PDA1 | PDA1 | — | PDA4 | PDA4 | — | PDA1 | PDA1 |
| | content | 50 | 30 | — | 40 | 30 | — | 50 | 30 |
| | (parts | | | | | | | | |
| | by weight) | | | | | | | | |
| | Type | — | — | A-3 | A-4 | A-4 | A-4 | — | — |
| | content | — | — | 100 | 20 | 40 | 50 | — | — |
| | (parts | | | | | | | | |
| | by weight) | | | | | | | | |
| Cyclic compound having | Type | B-1 | B-1 | B-1 | B-1 | B-1 | B-1 | B-1 | B-1 |
| glycidyl group or acid | content | 1.0 | 1.0 | 1.0 | 1.0 | 1.0 | 1.0 | 1.0 | 1.0 |
| anhydride (B) | (parts | | | | | | | | |
| | by weight) | | | | | | | | |
| Solid-state polymerization | tempera- | 150 | 150 | 150 | — | — | — | — | — |
| | ture (° C.) | | | | | | | | |
| conditions | time (hr) | 24 | 24 | 24 | — | — | — | — | — |
| Weight average | | 13 × 10⁴ | 15 × 10⁴ | 15 × 10⁴ | 18 × 10⁴ | 19 × 10⁴ | 18 × 10⁴ | 12 × 10⁴ | 14 × 10⁴ |
| molecular weight | | | | | | | | | |
| Dispersity | | 1.9 | 1.8 | 2.2 | 1.8 | 1.9 | 1.3 | 1.9 | 1.8 |
| Melting point | ° C. | 215 | 214/168 | 213/168 | 211/169 | 210/167 | 209/168 | 213 | 214/152 |
| (Tm-Tms)/(Tme-Tm) | | 1.7 | 1.5 | 1.6 | 1.6 | 1.5 | 1.7 | 2.1 | 2.0 |
| ΔHmsc | | 43 | 33 | 30 | 31 | 35 | 32 | 28 | 24 |
| Sc | % | 100 | 93 | 98 | 91 | 97 | 95 | 100 | 94 |
| Caboxyl terminal | eq/ton | 4 | 2 | 1 | 1 | 2 | 3 | 10 | 7 |
| concentration | | | | | | | | | |
| Molecular weight retention | % | 91 | 95 | 90 | 92 | 93 | 89 | 84 | 89 |
| Strength of stretched yarn | cN/dtex | 3.9 | 4.2 | 4.1 | 4.1 | 4.3 | 3.8 | 2.9 | 3.5 |
| Strength retention | % | 84 | 89 | 88 | 85 | 86 | 87 | 74 | 81 |
| of stretched yarn | | | | | | | | | |
| Iron heat resistance of fabric | | good | good | good | good | good | good | fair | fair |
| Heat resistance of molded | mm | 7 | 7 | 8 | 10 | 9 | 10 | 16 | 18 |
| article (deformation amount) | | | | | | | | | |
| Dry heat strength retention | % | 65 | 67 | 68 | 61 | 64 | 58 | 40 | 45 |
| of molded article | | | | | | | | | |

In Examples 22 and 23, a polylactic acid resin composition was not preliminarily prepared as the polylactic acid resin (A). PLA3, PDA1, and triglycidyl isocyanurate (B-1) were melt-mixed together at once, and then subjected to solid-state polymerization. As a result, the reaction with the isocyanurate compound caused a slight increase in the weight average molecular weight of each polylactic acid resin composition, and the polydispersity tended to decrease. In the polylactic acid resin compositions prepared by this method, the carboxyl terminal concentration was less than 10 eq/ton, and the molecular weight retention rate was high so that the compositions were found to have excellent wet heat stability. Properties of the stretched yarns tended to be similar to those in Examples 1 to 21, indicating excellent mechanical properties, hydrolysis resistance, and iron heat resistance. The molded articles showed deformations of not more than 10 mm in the heat sag test, and tensile strength retentions of not less than 60% so that the molded articles were found to have excellent heat resistance and dry heat properties.

Also in Example 24, in which triglycidyl isocyanurate (B-1) was added before the solid-state polymerization unlike Examples 1 to 21, the reaction with the isocyanurate compound caused an increase in the weight average molecular weight of the polylactic acid resin composition, and the polydispersity tended to decrease, similarly to Examples 1 to 21. The polylactic acid resin composition obtained by this method also showed a carboxyl terminal concentration of as low as 1 eq/ton, and the molecular weight retention rate was as high as 90%, similarly to the Examples. The properties of the stretched yarn, and the physical properties and the heat resistance of the molded article were also excellent, similarly to the Examples.

In Examples 25 to 27, in terms of physical properties of the obtained polylactic acid resin compositions, the reaction with triglycidyl isocyanurate (B-1) caused a slight increase in the weight average molecular weight, and the polydispersity tended to decrease, similarly to the Examples. The polylactic acid resin compositions prepared by this method also showed carboxyl terminal concentrations of less than 10 eq/ton, and their molecular weight retention rates were high so that the compositions were found to have excellent wet heat stability. The stretched yarns also showed tendencies similar to those in Examples 1 to 21 so that they were found to have excellent mechanical properties, hydrolysis resistance, and iron heat resistance. The injection-molded articles showed deformations of not more than 10 mm in the heat sag test, and tensile strength retentions of not less than 58% so that the injection-molded articles were found to have excellent heat resistance and dry heat properties.

In Comparative Examples 23 and 24, PLA3, PDA1, and triglycidyl isocyanurate (B-1) were melt-mixed together at once similarly to Examples 22 and 23, but the subsequent solid-state polymerization was not carried out. Therefore, the weight average molecular weight was smaller than those in Examples 22 and 23, and the crystal melting enthalpy of the stereocomplex crystals was low so that the heat resistance was low. In terms of properties of the stretched yarns, the strength retention was high, and the hydrolysis resistance was therefore excellent, but the stretched-yarn strength was lower than those in Examples 22 and 23. In the heat sag test of the injection-molded articles, deformation was larger than those in Examples 22 and 23, and the dry heat strength retention was less than 50% so that the molded articles tended to have lower heat resistance and dry heat properties.

### INDUSTRIAL APPLICABILITY

The polylactic acid resin composition has better mechanical properties, durability, and heat resistance, as well as excellent wet heat properties and dry heat properties, due to the end-capping effect of the cyclic compound containing a glycidyl group and/or acid anhydride. Thus, the composition can be preferably employed in fields in which heat resistance, wet heat properties, and/or dry heat properties is/are required.

1.-16. (canceled)

17. A polylactic acid resin composition comprising: 100 parts by weight of a (A) polylactic acid block copolymer constituted of a poly-L-lactic acid segment(s) containing as a major component L-lactic acid and a poly-D-lactic acid segment(s) containing as a major component D-lactic acid; and 0.05 to 2 parts by weight of a (B) cyclic compound having a molecular weight of not more than 800 and containing a glycidyl group or acid anhydride;
wherein a degree of stereocomplexation (Sc) satisfies Equation (1):
Sc=ΔHh/(ΔHl+ΔHh)×100>80 (1)
wherein
ΔHh: heat of fusion of stereocomplex crystals (J/g) in DSC measurement of said polylactic acid resin composition, wherein temperature is increased at a heating rate of 20° C./min; and
ΔHl: heat of fusion of crystals (J/g) of poly-L-lactic acid alone and crystals of poly-D-lactic acid alone in DSC measurement of said polylactic acid resin composition, wherein temperature is increased at a heating rate of 20° C./min.

18. The polylactic acid resin composition according to claim 17, wherein said (B) cyclic compound containing a glycidyl group or acid anhydride is an isocyanurate compound represented by General Formula (1): 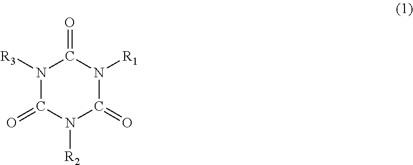
(wherein R₁-R₃ may be the same or different, and at least one of R₁-R₃ represents a glycidyl group while each of the others represents a functional group selected from the group consisting of hydrogen, C₁-C₁₀ alkyl, hydroxyl, and allyl).

19. The polylactic acid resin composition according to claim 18, wherein said compound represented by General Formula (1) is at least one compound selected from the group consisting of diallyl monoglycidyl isocyanurate, monoallyl diglycidyl isocyanurate, and triglycidyl isocyanurate.

20. The polylactic acid resin composition according to claim 17, wherein said (B) cyclic compound containing a glycidyl group or acid anhydride is at least one compound selected from the group consisting of diglycidyl phthalate, diglycidyl terephthalate, diglycidyl tetrahydrophthalate, diglycidyl hexahydrophthalate, cyclohexanedimethanol diglycidyl ether, phthalic anhydride, maleic anhydride, pyromellitic dianhydride, trimellitic anhydride, 1,2-cyclohexanedicarboxylic anhydride, and 1,8-naphthalenedicarboxylic anhydride.

21. The polylactic acid resin composition according to claim 17, wherein the carboxyl terminal concentration of said polylactic acid resin composition is not more than 10 eq/ton.

22. The polylactic acid resin composition according to claim 17, wherein the weight average molecular weight of said polylactic acid resin composition after 100 hours of moist heat treatment at 60° C. under 95% RH is not less than 80% of the weight average molecular weight before the moist heat treatment.

23. The polylactic acid resin composition according to claim 17, wherein the crystal melting enthalpy of said polylactic acid resin composition is not less than 30 J/g at not less than 190° C. during DSC measurement in which the temperature is increased to 250° C.

24. The polylactic acid resin composition according to claim 17, wherein said (A) polylactic acid block copolymer is obtained by mixing poly-L-lactic acid and poly-D-lactic acid in Combination 1 and/or Combination 2 to obtain a mixture having a weight average molecular weight of not less than 90,000 and a degree of stereocomplexation (Sc) satisfying Equation (2), and then performing solid-state polymerization at a temperature lower than the melting point of said mixture:
(Combination 1) one of the poly-L-lactic acid and the poly-D-lactic acid has a weight average molecular weight of 60,000 to 300,000, and the other has a weight average molecular weight of 10,000 to 100,000;
(Combination 2) the ratio between the weight average molecular weight of the poly-L-lactic acid and the weight average molecular weight of the poly-D-lactic acid is not less than 2 and less than 30;
Sc=ΔHh/(ΔHl+ΔHh)×100>60 (2)
wherein
ΔHh: heat of fusion of stereocomplex crystals (J/g) in DSC measurement wherein temperature is increased at a heating rate of 20° C./min; and
ΔHl: heat of fusion of crystals (J/g) of poly-L-lactic acid alone and crystals of poly-D-lactic acid alone in DSC measurement wherein temperature is increased at a heating rate of 20° C./min.

25. The polylactic acid resin composition according to claim 17, wherein said (A) polylactic acid block copolymer is obtained by mixing poly-L-lactic acid and poly-D-lactic acid in Combination 3 and/or Combination 4 to obtain a mixture having a weight average molecular weight of not less than 90,000 and a degree of stereocomplexation (Sc) satisfying Equation (2), and then performing solid-state polymerization at a temperature lower than the melting point of said mixture:
(Combination 3) one of the poly-L-lactic acid and the poly-D-lactic acid has a weight average molecular weight of 120,000 to 300,000, and the other has a weight average molecular weight of 30,000 to 100,000;
(Combination 4) the ratio between the weight average molecular weight of the poly-L-lactic acid and the weight average molecular weight of the poly-D-lactic acid is not less than 2 and less than 30;
Sc=ΔHh/(ΔHl+ΔHh)×100>60 (2)
wherein
ΔHh: heat of fusion of stereocomplex crystals (J/g) in DSC measurement of said mixture of poly-L-lactic acid and poly-D-lactic acid, wherein temperature is increased at a heating rate of 20° C./min; and
ΔHl: heat of fusion of crystals (J/g) of poly-L-lactic acid alone and crystals of poly-D-lactic acid alone in DSC measurement of said mixture of poly-L-lactic acid and poly-D-lactic acid, wherein temperature is increased at a heating rate of 20° C./min.

26. The polylactic acid resin composition according to claim 17, wherein polydispersity, which is represented as a ratio between weight average molecular weight and number average molecular weight, is not more than 2.5.

27. The polylactic acid resin composition according to claim 17, having a weight average molecular weight of 100,000 to 500,000.

28. The polylactic acid resin composition according to claim 17, further comprising (b) poly-L-lactic acid and/or (c) poly-D-lactic acid.

29. A molded product comprising the polylactic acid resin composition according to claim 17.

30. A method of producing the polylactic acid resin composition according to claim 17, said method comprising:
mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000; or a ratio between weight average molecular weight of the poly-L-lactic acid and weight average molecular weight of the poly-D-lactic acid is not less than 2 and less than 30;
performing solid-state polymerization at a temperature lower than the melting point of the resulting mixture; and
adding said (B) cyclic compound containing a glycidyl group or acid anhydride to the mixture.

31. A method of producing the polylactic acid resin composition according to claim 17, said method comprising:
mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000; or a ratio between weight average molecular weight of the poly-L-lactic acid and weight average molecular weight of the poly-D-lactic acid is not less than 2 and less than 30;
adding said (B) cyclic compound containing a glycidyl group or acid anhydride to the resulting mixture; and
performing solid-state polymerization at a temperature lower than the melting point of the mixture.

32. A method of producing the polylactic acid resin composition according to claim 17, said method comprising:
mixing poly-L-lactic acid and poly-D-lactic acid, wherein one of the poly-L-lactic acid and the poly-D-lactic acid has a weight average molecular weight of 60,000 to 300,000, and the other has a weight average molecular weight of 10,000 to 100,000, with said (B) cyclic compound containing a glycidyl group or acid anhydride; or mixing poly-L-lactic acid and poly-D-lactic acid, wherein a ratio between weight average molecular weight of the poly-L-lactic acid and weight average molecular weight of the poly-D-lactic acid is not less than 2 and less than 30, with said (B) cyclic compound containing a glycidyl group or acid anhydride; and
performing solid-state polymerization at a temperature lower than the melting point of the resulting mixture.
